(19) United States
(12) Patent Application Publication
(10) Pub. No.: US 2024/0352606 A1
(43) Pub. Date: Oct. 24, 2024

(54) BREAK-RESISTANT PARTITION WALL COMPRISING SOLID ELECTROLYTE CERAMICS FOR ELECTROLYTIC CELLS

(71) Applicant: Evonik Operations GmbH, Essen (DE)

(72) Inventors: Philip Heinrich Reinsberg, Rheinbach (DE); Michael Horn, Niederkassel (DE); Patrik Stenner, Hanau (DE); Tobias Stadtmüller, Seligenstadt (DE); Johannes Ruwwe, Hanau (DE); Jutta Malter, Darmstadt (DE)

(21) Appl. No.: 18/292,986

(22) PCT Filed: Jul. 19, 2022
(86) PCT No.: PCT/EP2022/070127

§ 371 Date: Jan. 29, 2024

(30) Foreign Application Priority Data
Jul. 29, 2021 (EP) 21188434.1

(51) Int. Cl. C25B 13/07; C25B 3/07; C25B 3/13; C25B 9/60

(52) U.S. Cl. CPC C25B 13/07; C25B 3/07; C25B 3/13; C25B 9/60

(57) ABSTRACT

The present invention relates, in a first aspect, to a dividing wall W suitable for use in an electrolysis cell E. The dividing wall W comprises a frame element R that forms an edge element R_{R} and a separating element R_{T}. The frame element R comprises two opposite parts R₁ and R₂, with at least two alkali metal cation-conducting solid-state electrolyte ceramics F_{A} and F_{B} disposed therebetween. The separating element R_{T} lies between alkali metal cation-conducting solid-state electrolyte ceramics encompassed by the dividing wall W and separates these from one another. It is a feature of the invention that the two parts R₁ and R₂ are secured to one another by at least one securing element B_{R} at the edge element R_{R} and at least one securing element B_{T} at the separating element R_{T}.

Compared to the cases according to the prior art in which the dividing wall W encompasses the solid-state electrolyte in one piece, this arrangement is firstly more flexible since the individual ceramics have more degrees of freedom available in order to react to fluctuations in temperature, for example by shrinkage or expansion. This increases stability with respect to mechanical stresses in the ceramic. At the same time, the mechanical stability of the arrangement of the at least two solid-state electrolyte ceramics between the parts R₁ and R₂ is increased in that the parts R₁ and R₂ are secured to one another both at the edge element R_{R} and at the separating element R_{T} by at least one securing element B_{R} or B_{T}.

In a second aspect, the present invention relates to an electrolysis cell E encompassing a cathode chamber K_{K} divided by the dividing wall W from the adjacent chamber, which is the anode chamber K_{A} or a middle chamber K_{M} of the electrolysis cell E.

In a third aspect, the present invention relates to a process for producing an alkali metal alkoxide solution in the electrolysis cell E according to the second aspect of the invention.

The present invention relates, in a first aspect, to a dividing wall W suitable for use in an electrolysis cell E. The dividing wall W comprises a frame element R that forms an edge element R_{R} and a separating element R_{T}. The frame element R comprises two opposite parts R₁ and R₂, with at least two alkali metal cation-conducting solid-state ceramics F_{A} and F_{B} disposed therebetween. The separating element R_{T} lies between the alkali metal cation-conducting solid-state electrolyte ceramics encompassed by the dividing wall W and separates these from one another.

It is a feature of the invention that the two parts R₁ and R₂ are secured to one another by at least one securing element B_{R} at the edge element R_{R} and at least one securing element B_{T} at the separating element R_{T}.

Compared to the cases according to the prior art in which the dividing wall W encompasses the solid-state electrolyte in one piece, this arrangement is firstly more flexible since the individual ceramics have more degrees of freedom available in order to react to fluctuations in temperature, for example by shrinkage or expansion. This increases stability with respect to mechanical stresses in the ceramic. At the same time, the mechanical stability of the arrangement of the at least two solid-state electrolyte ceramics between the parts R₁ and R₂ is increased in that the parts R₁ and R₂ are secured to one another both at the edge element R_{R} and at the separating element R_{T} by at least one securing element B_{R} or B_{T}.

In a second aspect, the present invention relates to an electrolysis cell E encompassing a cathode chamber K_{K} divided by the dividing wall W from the adjacent chamber, which is an anode chamber K_{A} or a middle chamber K_{M} of the electrolysis cell E.

In a third aspect, the present invention relates to a process for producing an alkali metal alkoxide solution in the electrolysis cell E according to the second aspect of the invention.

### 1. BACKGROUND OF THE INVENTION

The electrochemical production of alkali metal alkoxide solutions is an important industrial process which is described, for example, in DE 103 60 758 A1, US 2006/0226022 A1 and WO 2005/059205 A1. The principle of these processes is reflected in an electrolysis cell in which the solution of an alkali metal salt, for example sodium chloride or NaOH, is present in the anode chamber, and the alcohol in question or an alcoholic solution with a low concentration of the alkali metal alkoxide in question, for example sodium methoxide or sodium ethoxide, is present in the cathode chamber. The cathode chamber and the anode chamber are separated by a ceramic that conducts the alkali metal ion used, for example NaSICON or an analogue for potassium or lithium. On application of a current, chlorine forms at the anode—when a chloride salt of the alkali metal is used—and hydrogen and alkoxide ions at the cathode. The charge is balanced in that alkali metal ions migrate from the middle chamber into the cathode chamber via the ceramic that is selective therefor. The balancing of charge between middle chamber and anode chamber results from the migration of cations when cation exchange membranes are used or the migration of anions when anion exchange membranes are used, or from migration of both ion types when non-specific diffusion barriers are used. This increases the concentration of the alkali metal alkoxide in the cathode chamber, and the concentration of the sodium ions in the anolyte is lowered.

NaSICON solid-state electrolytes are also used in the electrochemical production of other compounds:

WO 2014/008410 A1 describes an electrolytic process for producing elemental titanium or rare earths. The basis of this process is that titanium chloride is formed from TiO₂ and the corresponding acid, and this is reacted with sodium alkoxide to give titanium alkoxide and NaCl and finally converted electrolytically to elemental titanium and sodium alkoxide.

WO 2007/082092 A2 and WO 2009/059315 A1 describe processes for producing biodiesel, in which, with the aid of alkoxides produced electrolytically by means of NaSICON, triglycerides are first converted to the corresponding alkali metal triglycerides and are reacted in a second step with electrolytically generated protons to give glycerol and the respective alkali metal hydroxide.

However, these solid-state electrolyte ceramics typically have some disadvantages. In the operation of the electrolysis cell, there will inevitably be fluctuations in temperature in the cell, which result in expansion or shrinkage of the solid-state electrolyte ceramic. Since these ceramics are brittle, this can lead to fracture of the ceramic.

This problem arises particularly in the constantly repeating startup and shutdown processes that are unavoidable in the operation of electrolysis. During the heating and cooling, there are expansion and shrinkage phases, which results in movement of the ceramic back and forth in the electrolysis cell. These movements, on account of the uncontrolled distribution of forces in the ceramic, can cause it to break.

This can result in losses of integrity that can lead to leakage of brine into alcohol or vice versa. As a result, the product of the electrolysis—the alkoxide solution—is watered down. In addition, the electrolysis cell itself can also lose integrity and leak.

It was therefore the object of the present invention to provide an electrolysis cell that does not have these disadvantages.

A further disadvantage of conventional electrolysis cells in this technical field arises from the fact that the solid-state electrolyte does not have long-term stability with respect to aqueous acids. This is problematic in that, during the electrolysis in the anode chamber, the pH falls as a result of oxidation processes (for example in the case of production of halogens by disproportionation or by oxygen formation). These acidic conditions attack the NaSICON solid-state electrolyte to such a degree that the process cannot be used on an industrial scale. In order to counter this problem, various approaches have been described in the prior art.

For instance, three-chamber cells have been proposed in the prior art. These are known in the field of electrodialysis, for example U.S. Pat. No. 6,221,225 B1.

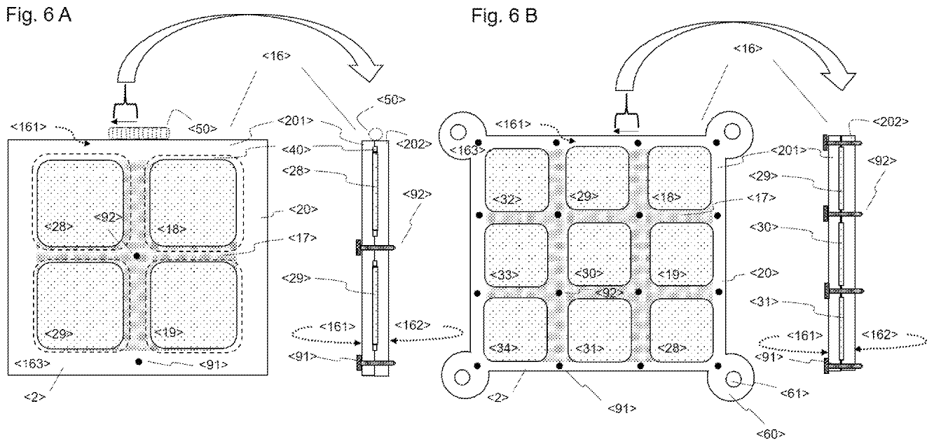

WO 2012/048032 A2 and US 2010/0044242 A1 describe, for example, electrochemical processes for producing sodium hypochlorite and similar chlorine compounds in such a three-chamber cell. The cathode chamber and the middle chamber of the cell are separated here by a solid-state electrolyte permeable to cations, for example NaSICON. In order to protect this from the acidic anolyte, the middle chamber is supplied, for example, with solution from the cathode chamber. US 2010/0044242 A1 also describes, in FIG. 6, the possibility of mixing solution from the middle chamber with solution from the anode chamber outside the chamber in order to obtain sodium hypochlorite.

Such cells have also been proposed in the prior art for the production or purification of alkali metal alkoxides.

For instance, U.S. Pat. No. 5,389,211 A describes a process for purifying alkoxide solutions in which a three-chamber cell is used, in which the chambers are delimited from one another by cation-selective solid-state electrolytes or else nonionic dividing walls. The middle chamber is used as buffer chamber in order to prevent the purified alkoxide or hydroxide solution from the cathode chamber from mixing with the contaminated solution from the anode chamber.

DE 42 33 191 A1 describes the electrolytic recovery of alkoxides from salts and alkoxides in multichamber cells and stacks of multiple cells.

WO 2008/076327 A1 describes a process for producing alkali metal alkoxides. This uses a three-chamber cell, the middle chamber of which has been filled with alkali metal alkoxide (see, for example, paragraphs [0008] and [0067] of WO 2008/076327 A1). This protects the solid-state electrolyte separating the middle chamber and the cathode chamber from the solution present in the anode chamber, which becomes more acidic in the course of electrolysis. A similar arrangement is described by WO 2009/073062 A1. However, this arrangement has the disadvantage that the alkali metal alkoxide solution which is consumed as buffer solution and continuously contaminated is the desired product. A further disadvantage of the process described in WO 2008/076327 A1 is that the formation of the alkoxide in the cathode chamber depends on the diffusion rate of the alkali metal ions through two membranes or solid-state electrolytes. This in turn leads to slowing of the formation of the alkoxide.

A further problem results from the geometry of the three-chamber cell. The middle chamber in such a chamber is separated from the anode chamber by a diffusion barrier and from the cathode chamber by an ion-conducting ceramic. During the electrolysis, this results unavoidably in development of pH gradients and in dead volumes. This can damage the ion-conducting ceramic and, as a result, increase the voltage demand of the electrolysis and/or lead to fracture of the ceramic.

While this effect takes place throughout the electrolysis chamber, the drop in pH is particularly critical in the middle chamber since this is bounded by the ion-conducting ceramic. Gases are typically formed at the anode and the cathode, such that there is at least some degree of mixing in these chambers. By contrast, no such mixing takes place in the middle chamber, such that the pH gradient develops therein. This unwanted effect is enhanced by the fact that the brine is generally pumped relatively slowly through the electrolysis cell.

It was therefore a further object of the present invention to provide an improved process for electrolytic production of alkali metal alkoxides, and also an electrolysis cell especially suitable for such a process. These are not to have the aforementioned disadvantages, and are especially to assure improved protection of the solid-state electrolyte prior to the formation of the pH gradient and more sparing use of the reactants compared to the prior art.

### 2. BRIEF DESCRIPTION OF THE INVENTION

The problem addressed by the invention is solved by a dividing wall W according to the first aspect of the invention. The dividing wall W <16> comprises one side S_{KK} <161> having the surface O_{KK} <163> and, opposite the side S_{KK} <161>, a side S_{A/MK} <162> having the surface O_{A/MK} <164>.

The dividing wall W <16> also encompasses a frame element R <2> composed of two opposite parts R₁ <201> and R₂ <202>, with at least two alkali metal cation-conducting solid-state electrolyte ceramics F_{A} <18> and F_{B} <19> disposed therebetween.

At the same time, R₁ <201> is directly contactable via the surface O_{KK} <163>, and R₂ <202> is directly contactable via the surface O_{A/MK} <164>.

The frame element R <2> forms a frame element R_{R} <20> and a separating element R_{T} <17>, with the frame element R_{R} <20> bounding, preferably fully surrounding, the surfaces O_{KK} <163> and O_{A/MK} <164>, and with the frame element R_{T} <17> lying between the alkali metal cation-conducting solid-state electrolyte ceramics encompassed by the dividing wall W <16> and dividing these from one another, such that the alkali metal cation-conducting solid-state electrolyte ceramics encompassed by the dividing wall W <16> are directly contactable both via the surface O_{KK} <163> and via the surface O_{A/MK} <164>.

The dividing wall W <16> is characterized in that R₁ <201> and R₂ <202> are secured to one another by at least one securing element B_{R} <91> at the edge element R_{R} <20>, and R₁ <201> and R₂ <202> are secured to one another by at least one securing element B_{T} <92> at the separating element R_{T} <17>.

In a second aspect, the present invention relates to an electrolysis cell E <1> comprising
at least one anode chamber K_{A} <11> having at least one inlet Z_{KA} <110>, at least one outlet A_{KA} <111>, and an interior I_{KA} <112> comprising an anodic electrode E_{A} <113>,
at least one cathode chamber K_{K} <12> having at least one inlet Z_{KK} <120>, at least one outlet A_{KK} <121>, and an interior I_{KK} <122> comprising a cathodic electrode E_{K} <123>,
and optionally at least one interposed middle chamber K_{M} <13> having at least one inlet Z_{KM} <130>, at least one outlet A_{KM} <131> and an interior I_{KM} <132>, where I_{KA} <112> and I_{KM} <132> are then divided from one another by a diffusion barrier D <14>, and A_{KM} <131> is connected by a connection V_{AM} <15> to the inlet Z_{KA} <110>, such that liquid can be passed from I_{KM} <132> into I_{KA} <112> via the connection V_{AM} <15>,
   wherein
in the cases in which the electrolysis cell E <1> does not comprise a middle chamber K_{M} <13>, I_{KA} <112> and I_{KK} <122> are divided from one another by a dividing wall W <16> according to the first aspect of the invention,
in the cases in which the electrolysis cell E <1> comprises at least one middle chamber K_{M} <13>, I_{KK} <122> and I_{KM} <132> are divided from one another by a dividing wall W <16> according to the first aspect of the invention,
   characterized in that
   the alkali metal cation-conducting solid-state ceramics encompassed by the dividing wall W <16>, and especially also the separating element R_{T} <17>, directly contact the interior I_{KK} <122> on the S_{KK} side <161> via the surface O_{KK} <163>, and
in the cases in which the electrolysis cell E <1> does not comprise a middle chamber K_{M} <13>, the alkali metal cation-conducting solid-state ceramics encompassed by the dividing wall W <16>, and especially also the separating element R_{T} <17>, directly contact the interior I_{KA} <112> on the side S_{A/MK} <162> via the surface O_{A/MK} <164>,
in the cases in which the electrolysis cell E <1> comprises at least one middle chamber K_{M} <13>, the alkali metal cation-conducting solid-state ceramics encompassed by the dividing wall W <16>, and especially also the separating element R_{T} <17>, directly contact the interior I_{KM} <132> on the side S_{A/MK} <162> via the surface O_{A/MK} <164>,

In a third aspect, the present invention relates to a process for producing a solution L₁ of an alkali metal alkoxide XOR in the alcohol ROH, where X is an alkali metal cation and R is an alkyl radical having 1 to 4 carbon atoms,
(α) wherein the following steps (α1), (α2), (α3) that proceed simultaneously are conducted in an electrolysis cell E according to the second aspect of the invention that does not comprise a middle chamber K_{M}:
   (α1) a solution L₂ comprising the alcohol ROH is routed through K_{K},
   (α2) a neutral or alkaline, aqueous solution L₃ of a salt S comprising X as cation is routed through K_{A},
   (α3) voltage is applied between E_{A} and E_{K},
      or
(β) wherein the following steps (β1), (β2), (β3) that proceed simultaneously are conducted in an electrolysis cell E according to the second aspect of the invention that comprises a middle chamber K_{M}:
   (β1) a solution L₂ comprising the alcohol ROH is routed through K_{K},
   (β2) a neutral or alkaline, aqueous solution L₃ of a salt S comprising X as cation is routed through K_{M}, then through V_{AM}, then through K_{A},
   (β3) voltage is applied between E_{A} and E_{K}, which affords the solution L₁ at the outlet A_{KK} with a higher concentration of XOR in Li than in L₂, and which affords an aqueous solution L₄ of S at the outlet A_{KA}, with a lower concentration of S in L₄ than in L₃.

### 3. FIGURES

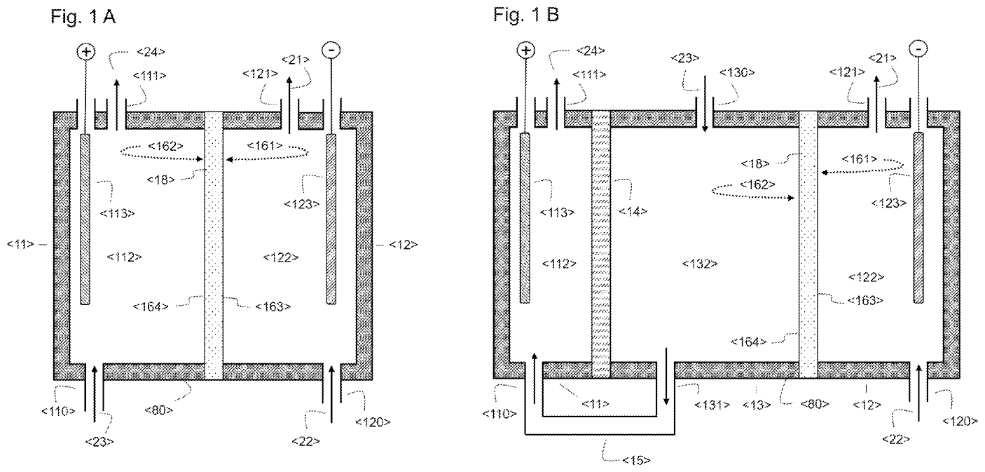

### 3.1 FIGS. 1 A and 1 B

FIG. 1 A (=“FIG. 1 A”) shows a non-inventive electrolysis cell E. This comprises a cathode chamber K_{K} <12> and an anode chamber K_{A} <11>.

The cathode chamber K_{K} <12> comprises a cathodic electrode E_{K} <123> in the interior I_{KK} <122>, an inlet Z_{KK} <120> and an outlet A_{KK} <121>.

The anode chamber K_{A} <11> comprises an anodic electrode E_{A} <113> in the interior I_{KA} <112>, an inlet Z_{KK} <110> and an outlet A_{KA} <111>.

The two chambers are bounded by an outer wall <80> of the two-chamber cell E. The interior I_{KK} <122> is also divided from the interior I_{KA} <112> by a dividing wall consisting of a sheet of a NaSICON solid-state electrolyte F_{A} <18> which is selectively permeable to sodium ions. The NaSICON solid-state electrolyte F_{A} <18> extends over the entire depth and height of the two-chamber cell E. The dividing wall has two sides S_{KK} <161> and S_{A/MK} <162>, the surfaces O_{KK} <163> and O_{A/MK} <164> of which contact the respective interior I_{KK} <122> or I_{KA} <112>.

An aqueous solution of sodium chloride L₃ <23> with pH 10.5 is introduced via the inlet Z_{KA} <110>, counter to the direction of gravity, into the interior I_{KA} <112>.

A solution of sodium methoxide in methanol L₂ <22> is routed into the interior I_{KK} <122> via the inlet Z_{KK} <120>.

At the same time, a voltage is applied between the cathodic electrode E_{K} <123> and the anodic electrode E_{A} <113>. This results in reduction of methanol in the electrolyte L₂ <22> to give methoxide and H₂ in the interior I_{KK} <122> (CH₃OH+e⁻→CH₃O⁻+½ H₂). At the same time, sodium ions diffuse from the interior I_{KA} <112> through the NaSICON solid-state electrolyte F_{K} <18> into the interior I_{KK} <122>. Overall, this increases the concentration of sodium methoxide in the interior I_{KK} <122>, which affords a methanolic solution of sodium methoxide L₁ <21> having an elevated sodium methoxide concentration compared to L₂ <22>.

In the interior I_{KA} <112>, the oxidation of chloride ions takes place to give molecular chlorine (Cl⁻→½ Cl₂+e⁻). In the outlet A_{KA} <111>, an aqueous solution L₄ <24> is obtained, in which the content of NaCl is reduced compared to L₃ <23>. Chlorine gas (Cl₂) in water, according to the reaction Cl₂+H₂O→HOCl+HCl, forms hypochlorous acid and hydrochloric acid, which give an acidic reaction with further water molecules. The acidity damages the NaSICON solid-state electrolyte F_{A} <18>.

FIG. 1 B (=“FIG. 1 B”) shows a further non-inventive electrolysis cell E. This three-chamber cell E comprises a cathode chamber K_{K} <12>, an anode chamber K_{A} <11> and an interposed middle chamber K_{M} <13>.

The cathode chamber K_{K} <12> comprises a cathodic electrode E_{K} <123> in the interior I_{KK} <122>, an inlet Z_{KK} <120> and an outlet A_{KK} <121>.

The anode chamber K_{A} <11> comprises an anodic electrode E_{A} <113> in the interior I_{KA} <112>, an inlet Z_{KK} <110> and an outlet A_{KA} <111>.

The middle chamber K_{M} <13> comprises an interior I_{KM} <132>, an inlet Z_{KM} <130> and an outlet A_{KM} <131>.

The interior I_{KA} <112> is connected to the interior I_{KM} <132> via the connection V_{AM} <15>.

The three chambers are bounded by an outer wall <80> of the three-chamber cell E. The interior I_{KM} <132> of the middle chamber K_{M} <13> is also divided from the interior I_{KA} <122> of the cathode chamber K_{K} <12> by a dividing wall consisting of a sheet of a NaSICON solid-state electrolyte F_{A} <18> which is selectively permeable to sodium ions. The NaSICON solid-state electrolyte F_{A} <18> extends over the entire depth and height of the three-chamber cell E. The dividing wall has two sides S_{KK} <161> and S_{A/MK} <162>, the surfaces O_{KK} <163> and O_{A/MK} <164> of which contact the respective interior I_{KK} <122> or I_{KM} <132>.

The interior I_{KM} <132> of the middle chamber K_{M} <13> is additionally divided in turn from the interior I_{KA} <112> of the anode chamber K_{A} <11> by a diffusion barrier D <14>. The NaSICON solid-state electrolyte F_{A} <18> and the diffusion barrier D <14> extend over the entire depth and height of the three-chamber cell E. The diffusion barrier D <14> is a cation exchange membrane (sulfonated PTFE).

In the embodiment according to FIG. 1 B, the connection V_{AM} <15> is formed outside the electrolysis cell E, especially by a tube or hose, the material of which may be selected from rubber, metal and plastic. The connection V_{AM} <15> can guide liquid from the interior I_{KM} <132> of the middle chamber K_{M} <13> into the interior I_{KA} <112> of the anode chamber K_{A} <11> outside the dividing wall W_{A} <80> of the three-chamber cell E. The connection V_{AM} <15> connects an outlet A_{KM} <131> that penetrates the outer wall W_{A} <80> of the electrolysis cell E at the base of the middle chamber K_{M} <13> to an inlet Z_{KA} <110> that penetrates the outer wall W_{A} <80> of the electrolysis cell E at the base of the anode chamber K_{A} <11>.

An aqueous solution of sodium chloride L₃ <23> with pH 10.5 is introduced via the inlet Z_{KM} <130>, in the direction of gravity, into the interior I_{KM} <132> of the middle chamber K_{M}. The connection V_{AM} <15> formed between an outlet A_{KM} <131> from the middle chamber K_{M} <13> and an inlet Z_{KA} <110> to the anode chamber K_{A} <11> connects the interior I_{KM} <132> of the middle chamber K_{M} <13> to the interior I_{KA} <112> of the anode chamber K_{A} <11>. Sodium chloride solution L₃ <23> is routed through this connection V_{AM} <15> from the interior I_{KM} <132> into the interior I_{KA} <112>. A solution of sodium methoxide in methanol L₂ <22> is routed into the interior I_{KK} <122> via the inlet Z_{KK} <120>.

At the same time, a voltage is applied between the cathodic electrode E_{K} <123> and the anodic electrode E_{A} <113>. This results in reduction of methanol in the electrolyte L₂ <22> to give methoxide and H₂ in the interior I_{KK} <122> (CH₃OH+e⁻→CH₃O⁻+½ H₂). At the same time, sodium ions diffuse from the interior I_{KM} <132> of the middle chamber K_{M} <13> through the NaSICON solid-state electrolyte F_{A} <18> into the interior I_{KK} <122>. Overall, this increases the concentration of sodium methoxide in the interior I_{KK} <122>, which affords a methanolic solution of sodium methoxide L₁ <21> having an elevated sodium methoxide concentration compared to L₂ <22>.

In the interior I_{KA} <112>, the oxidation of chloride ions takes place to give molecular chlorine (Cl⁻→½ Cl₂+e⁻). At the outlet A_{KA} <111>, an aqueous solution L₄ <24> is obtained, in which the content of NaCl is reduced compared to L₃ <23>. Chlorine gas (Cl₂) in water, according to the reaction Cl₂+H₂O→HOCl+HCl, forms hypochlorous acid and hydrochloric acid, which give an acidic reaction with further water molecules. The acidity would damage the NaSICON solid-state electrolyte F_{A} <18>, but is restricted to the anode chamber K_{A} <11> by the arrangement in the three-chamber cell, and hence kept away from the NaSICON solid-state electrolyte F_{K} <18> in the electrolysis cell E. This considerably increases the lifetime thereof.

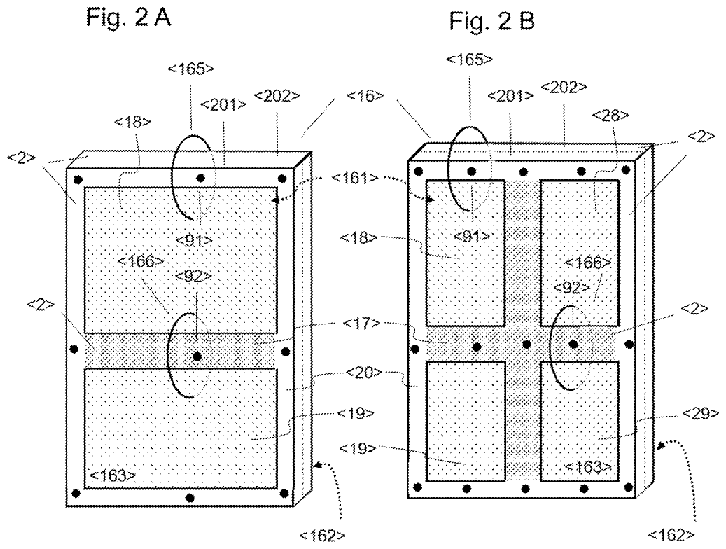

### 3.2 FIGS. 2 A and 2 B

FIG. 2 A (=“FIG. 2 A”) shows an inventive dividing wall W <16>. The side S_{KK} <161> with the surface O_{KK} <163> lies in the plane of the drawing, and the side S_{A/MK} <162> with the surface O_{A/MK} <164> not visible in FIG. 2 A lies behind the plane of the drawing.

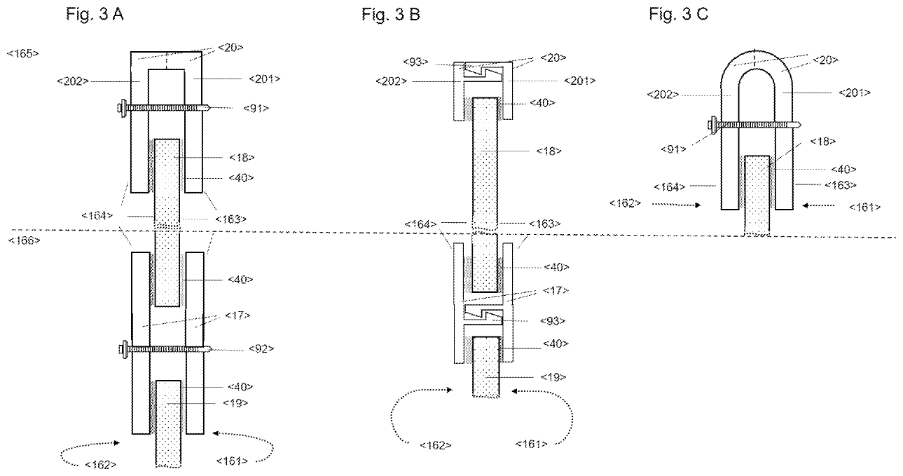

The dividing wall W <16> comprises two NaSICON solid-state electrolyte ceramics F_{A} <18> and F_{B} <19> disposed between a frame element R <2>. The frame element R <2> comprises two parts R₁ <201> and R₂ <202>, between which the ceramics F_{A} <18> and F_{B} <19> are disposed. The frame element R <2> here forms an edge element R_{R} <20> and a separating element R_{T} <17>. The separating element R_{T} <17> lies between the NaSICON solid-state electrolyte ceramics F_{A} <18> and F_{B} <19> and separates these from one another. The separating element R_{T} <17> is the part of the frame element R <2> shown in shaded form in FIGS. 2 A and 2 B. The edge element R_{R} <20> is the part of the frame element R <2> shown in non-shaded form in FIGS. 2 A and 2 B. The two frame parts R₁ <201> and R₂ <202> in the region of the edge element R_{R} <20> are secured to one another by eight securing elements B_{R} <91>, and in the region of the separating elements R_{T} <17> by a securing element B_{T} <92>. The views drawn show cross sections Q_{RR} <165> and Q_{RT} <166> through the dividing wall W <16> that are elucidated in detail in FIGS. 3 A to 3 C. Q_{RR} <165> and Q_{RT} <166> intersect the dividing wall W <16> at right angles to the surface O_{KK} <163> in the region of one of the two solid-state electrolyte ceramics F_{A} <18> and F_{B} <19>.

FIG. 2 B (=“FIG. 2 B”) shows another embodiment of an inventive dividing wall W <16>. This corresponds to the embodiment shown in FIG. 2, except that it comprises four NaSICON solid-state electrolyte ceramics F_{A} <18>, F_{B} <19>, F_{C} <28>, F_{D} <29>, with F_{A} <18>, F_{B} <19>, F_{C} <28> and F_{D} <29> being disposed between the frame parts R₁ <201> and R₂ <202>. The separating element R_{T} <17> has the shape of a cross. The two frame parts R₁ <201> and R₂ <202> in the region of the edge element R_{R} <20> are secured to one another by twelve securing elements B_{R} <91>, and in the region of the separating elements R_{T} <17> by three securing elements B_{T} <92>. The side S_{KK} <161> with the surface O_{KK} <163> lies in the plane of the drawing, and the side S_{A/MK} <162> with the surface O_{A/MK} <164> not visible in FIG. 2 B behind the plane of the drawing.

### 3.3 FIGS. 3 A to 3 C

FIGS. 3 A to 3 C each show, above the continuous dotted line, a detail view of the cross section Q_{RR} <165> shown in FIGS. 2 A and 2 B in the region of the edge element R_{R} <20> of the dividing wall W <16>. FIGS. 3 A and 3 B also show, below the continuous dotted line, a detail view of the cross section Q_{RT} <166> shown in FIGS. 2 A and 2 B in the region of the separating element R_{T} <17> of the dividing wall W <16>. The side S_{KK} <161> having the surface O_{KK} <163> is on the right-hand side of FIG. 3 A; the side S_{A/MK} <162> having the surface O_{A/MK} <164> is on the left-hand side of FIG. 3 A.

In FIG. 3 A (=“FIG. 3 A”), the solid-state electrolyte ceramic F_{A} <18>, in the cross section Q_{RR} <165>, is disposed between the two frame parts R₁ <201> and R₂ <202> that form the frame element R_{R} <20> here. These may exist in one piece or separately from one another, as indicated by the dotted line. They are preferably separate from one another. They are secured to one another by a screw as securing element B_{R} <91> and clamp the solid-state electrolyte ceramic F_{A} <18> between them. A seal Di <40> is preferably provided between the two frame parts R₁ <201> and R₂ <202> and the solid-state electrolyte ceramic F_{A} <18>.

In the cross section Q_{RT} <166>, the two solid-state electrolyte ceramics F_{A} <18> and F_{B} <19> are disposed between the two frame parts R₁ <201> and R₂ <202> which form the separating element R_{T} <17> here. They are secured to one another by a screw as securing element B_{T} <92> and clamp the solid-state electrolyte ceramics F_{A} <18> and F_{B} <19> between them, preferably with provision of a seal Di <40>.

FIG. 3 B (=“FIG. 3 B”) illustrates a further embodiment of each of the two cross sections Q_{RR} <165> and Q_{RT} <166>. This corresponds to the embodiment shown in FIG. 3 A, except that the two securing elements B_{R} <91> and B_{T} <92> are formed by hooks B_{H} <93>. These hooks may be in one-piece form (as shown here) together with the respective frame part R₁ <201> or R₂ <202>, or be bonded thereto. They engage with one another and enable securing of the two frame parts R₁ <201> and R₂ <202> to one another.

FIG. 3 C (=“FIG. 3 C”) illustrates a further embodiment of the cross section Q_{RR} <165>. This corresponds to the embodiment shown in FIG. 3 A, except that the edge element R_{R} <20> forms rounded corners.

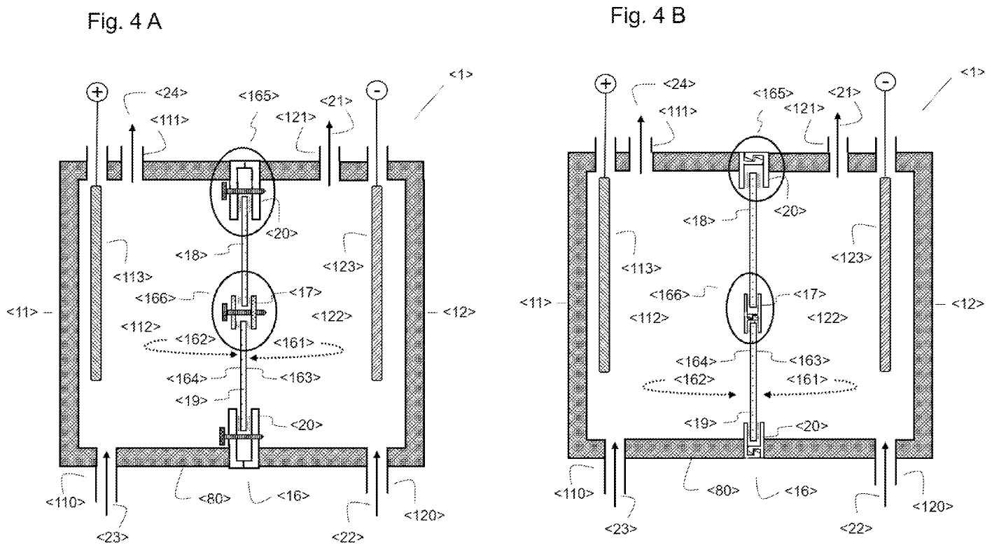

### 3.4 FIGS. 4 A and 4 B

FIGS. 4 A (=“FIG. 4 A”) and 4 B (=“Fig. B A”) each show an electrolysis cell E <1> according to the second aspect of the invention. These each correspond to the electrolysis cell shown in FIG. 1 A, except that a dividing wall W <16> separates the interior I_{KK} <122> of the cathode chamber K_{K} <12> from the interior I_{KA} <112> of the anode chamber K_{A} <11>. The dividing wall is that shown in FIG. 2 A or 2 B.

In this case, in the embodiment according to FIG. 4 A, a screw is used as securing elements B_{R} <91> and B_{T} <92>. The cross section Q_{RR} <165> in the region of the edge element R_{R} <20> of the dividing wall W <16> and the cross section Q_{RT} <166> in the region of the separating element R_{T} <17> of the dividing wall W <16> is in each case as described in FIG. 3 A.

In the embodiment according to FIG. 4 B, mutually engaging hooks B_{H} <93> are used as securing elements B_{R} <91> and B_{T} <92>. The cross section Q_{RR} <165> in the region of the edge element R_{R} <20> of the dividing wall W <16> and the cross section Q_{RT} <166> in the region of the separating element R_{T} <17> of the dividing wall W <16> is in each case as described in FIG. 3 B.

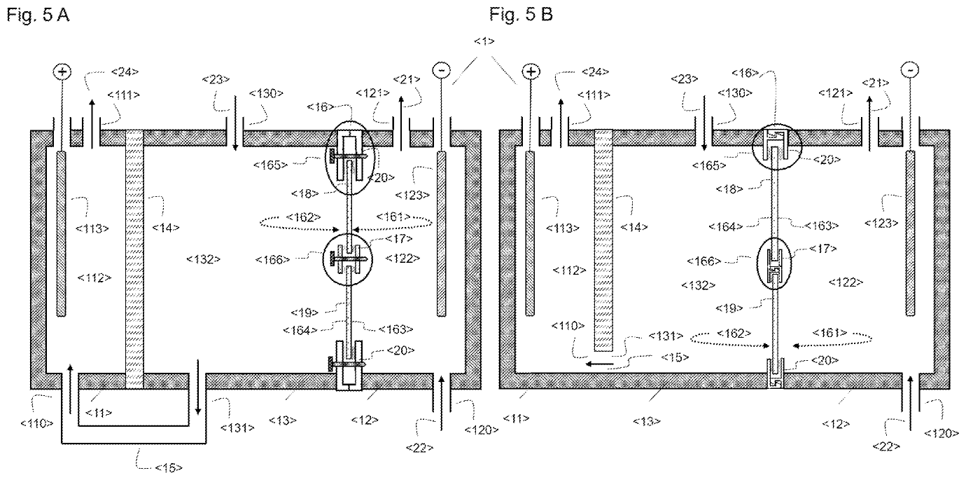

### 3.5 FIGS. 5 A and 5 B

FIG. 5 A (=“FIG. 5 A”) shows an electrolysis cell E <1> according to the second aspect of the invention. This corresponds to the electrolysis cell shown in FIG. 1 B, except that a dividing wall W <16> separates the interior I_{KK} <122> of the cathode chamber K_{K} <12> from the interior I_{KM} <132> of the middle chamber K_{M} <13>. The dividing wall W <16> is that shown in FIG. 2 A or 2 B. In this case, in the embodiment according to FIG. 4 A, a screw is used as securing elements B_{R} <91> and B_{T} <92>. The cross section Q_{RR} <165> in the region of the edge element R_{R} <20> of the dividing wall W <16> and the cross section Q_{RT} <166> in the region of the separating element R_{T} <17> of the dividing wall W <16> is in each case as described in FIG. 3 A.

FIG. 5 B (=“FIG. 5 B”) shows an electrolysis cell E <1> according to the second aspect of the invention. This corresponds to the electrolysis cell E <1> shown in FIG. 5 A with the following two differences:

1. The connection V_{AM} <15> from the interior I_{KM} <132> of the middle chamber K_{M} <13> to the interior I_{KA} <112> of the anode chamber K_{A} <11> is formed not outside the electrolysis cell E <1>, but rather inside through a perforation in the diffusion barrier D <14>. This perforation may be made in the diffusion barrier D <14> or may already have been present therein from the outset in the production of the diffusion barrier D <14> (for example in the case of textile fabrics such as filter cloths or metal weaves).

2. In the embodiment according to FIG. 5 B, mutually engaging hooks B_{H} <93> are used as securing elements B_{R} <91> and B_{T} <92>. The cross section Q_{RR} <165> in the region of the edge element R_{R} <20> of the dividing wall W <16> and the cross section Q_{RT} <166> in the region of the separating element R_{T} <17> of the dividing wall W <16> is in each case as described in FIG. 3 B.

The separating element R_{T} <17> is the part of the frame element R <2> shown in shaded form in FIGS. 6 A and 6 B.

### 3.6 FIGS. 6 A and 6 B

FIG. 6 A (=“FIG. 6 A”) shows a further embodiment of an inventive dividing wall W <16> in a top view of the side S_{KK} <161> having the surface O_{KK} <163> (on the left), and then as a side view of the detail that results from the curved clamp in the viewing direction of the arrow.

This comprises four NaSICON solid-state electrolyte ceramics F_{A} <18>, F_{B} <19>, F_{C} <28> and F_{D} <29>, which are disposed between two halves R₁ <201> and R₂ <202> of a frame element R <2>. The frame element R <2> here forms an edge element R_{R} <20> and a separating element R_{T} <17>. The separating element R_{T} <17> is cross-shaped and lies between the NaSICON solid-state electrolyte ceramics F_{A} <18>, F_{B} <19>, F_{C} <28> and F_{D} <29>, and separates these from one another. The separating element R_{T} <17> is the part of the frame element R <2> shown in shaded form in FIGS. 6 A and 6 B. The edge element R_{R} <20> is the part of the frame element R <2> shown in non-shaded form in FIGS. 6 A and 6 B. The two frame parts R₁ <201> and R₂ <202> in the region of the edge element R_{R} <20> are secured to one another by a securing element B_{R} <91>, and in the region of the separating elements R_{T} <17> by a securing element B_{T} <92>. They may optionally be connected to one another via a hinge <50>. A rubber ring as seal Di <40> is preferably provided in each case between the respective solid-state electrolyte ceramic F_{A} <18>, F_{B} <19>, F_{C} <28> and F_{D} <29> and the two frame parts R₁ <201> and R₂ <202>. The rings that function as seal Di <40> are given as dotted outlines in the front view on the left-hand side of FIG. 6 A.

FIG. 6 B (=“FIG. 6 B”) shows a further embodiment of an inventive dividing wall W <16>. This corresponds to the embodiment described in FIG. 6 A, except that it comprises nine NaSICON solid-state electrolyte ceramics F_{A} <18>, F_{B} <19>, F_{C} <28>, F_{D} <29>, F_{E} <30>, F_{F} <31>, F_{G} <32>, F_{H} <33>, F_{I} <34>. In addition, the frame element R <2> additionally has four bulges <60> each with a hole <61> (“rabbits' ears”), with which the dividing wall can be secured, for example, to a cathode chamber K_{K} <12> with appropriate designs.

### 4. DETAILED DESCRIPTION OF THE INVENTION

### 4.1 Dividing Wall W

The present invention relates in a first aspect to a dividing wall W. This is especially suitable as a dividing wall in an electrolysis cell, especially an electrolysis cell E.

In one aspect, the present invention thus also relates to an electrolysis cell comprising the dividing wall W, especially an electrolysis cell E comprising the dividing wall W.

The dividing wall W comprises at least two alkali metal cation-conducting solid-state electrolyte ceramics (“alkali metal cation-conducting solid-state electrolyte ceramic” is abbreviated hereinafter as “ASC”) F_{A} and F_{B}, separated from one another by a separating element R_{T}.

The dividing wall W comprises two sides S_{KK} and S_{A/MK} that are opposite one another, meaning that side S_{A/MK} is opposite side S_{KK} (and vice versa). The two sides S_{KK} and S_{A/MK} especially comprise planes that are essentially parallel to one another.

The geometry of the dividing wall W is otherwise subject to no further restriction, and may be matched in particular to the cross section of the electrolysis cell E in which it is used. For example, it may have the geometry of a cuboid and hence have a rectangular cross section, or the geometry of a frustocone or cylinder and accordingly a circular cross section.

Optionally, the dividing wall W may also have the geometry of a cuboid with rounded corners or bulges which may in turn have holes. The dividing wall W then has bulges (“rabbit's ears”) by which the dividing wall W can be fixed to electrolysis cells, or else the two frame parts R₁ and R₂ of the dividing wall W can be fixed to one another.

The side S_{KK} of the dividing wall W has the surface O_{KK}, and the side S_{A/MK} of the dividing wall W has the surface O_{A/MK}.

The dividing wall W encompasses a frame element R. This comprises two opposite parts, preferably halves, R₁ and R₂, with at least two alkali metal cation-conducting solid-state ceramics F_{A} and F_{B} disposed therebetween. R₁ is directly contactable via the surface O_{KK}; R₂ is directly contactable via the surface O_{A/MK}.

The frame element R forms a frame element R_{R} and a separating element R_{T}, with the frame element R_{R} bounding and preferably fully surrounding the surfaces O_{KK} and O_{A/MK}, and with the frame element R_{T} lying between alkali metal cation-conducting solid-state electrolyte ceramics encompassed by the dividing wall W and separating these from one another,
such that the alkali metal cation-conducting solid-state electrolyte ceramics encompassed by the dividing wall W are directly contactable both via the surface O_{KK} and via the surface O_{A/MK}.

What is meant by the feature “dividing wall” is that the dividing wall W is liquid-tight. This means that the ASCs and the frame element R gaplessly adjoin one another. Thus, no gaps exist between frame element R and the ASCs encompassed by the dividing wall W, through which aqueous solution, alcoholic solution, alcohol or water could flow from the S_{KK} side to the S_{A/MK} side or vice versa.

If there are two or more pairs of opposite sides via the surfaces of which the alkali metal cation-conducting solid-state electrolyte ceramics encompassed by the dividing wall W and the respective part R₁ or R₂ are directly contactable, the pair of opposite sides referred to as S_{KK} and S_{A/MK} in the context of the invention is preferably that pair which encompasses the greatest surface areas O_{KK} and O_{A/MK}. If the surface areas encompassed by two pairs of opposite sides are the same, the person skilled in the art can select one pair as S_{KK} and S_{A/MK} with surfaces O_{KK} and O_{A/MK}.

Among dividing walls W where there are two or more pairs of opposite sides via the surfaces of which the alkali metal cation-conducting solid-state electrolyte ceramics encompassed by the dividing wall W and the respective part R₁ or R₂ are directly contactable, preference is given to the dividing walls W where the surface areas encompassed by the respective pair of opposite sides are different, in which case the pair of opposite sides referred to as S_{KK} and S_{A/MK} in the context of the invention is that which encompasses the greatest surface areas O_{KK} and O_{A/MK}.

The dividing wall W according to the first aspect of the present invention also includes embodiments in which the dividing wall W comprises more than two ASCs, for example four or nine or twelve ASCs.

In the dividing wall W, all ASCs encompassed by the dividing wall W are separated from one another by the separating element R_{T} of the frame element R, meaning that no ASC directly adjoins another ASC, that is without a frame element R being in between.

The dividing wall W is further characterized in that the ASCs encompassed by the dividing wall W are directly contactable both via the surface O_{KK} and via the surface O_{A/MK}.

What is meant by “directly contactable” with regard to the ASCs encompassed by the dividing wall W is that some of the surfaces O_{KK} and O_{A/MK} are formed by the surface of the ASCs encompassed by the dividing wall W, meaning that the ASCs encompassed by the dividing wall W are directly accessible at the two surfaces O_{KK} and O_{A/MK}, such that they can be wetted at the two surfaces O_{KK} and O_{A/MK}, for example, with aqueous solution, alcoholic solution, alcohol or water.

What this means for the arrangement of the ASCs in the dividing wall W is that, for each ASC encompassed by the dividing wall W, there is a route from the surface O_{KK} on the side S_{KK} to the surface O_{A/MK} on the side S_{A/MK} that leads completely through the respective ASC.

The two frame elements R₁ and R₂ are directly contactable via the surfaces O_{KK} and O_{A/MK}.

What is meant by “directly contactable” with regard to the frame part R₁ encompassed by the dividing wall W is that part of the surface O_{KK} is formed by the surface of the frame part R₁, meaning that the frame part R₁ is directly accessible at the surface O_{KK}, such that it can be wetted at the surface O_{KK}, for example, with aqueous solution, alcoholic solution, alcohol or water.

What is meant by “directly contactable” with regard to the frame part R₂ encompassed by the dividing wall W is that part of the surface O_{A/MK} is formed by the surface of the frame part R₂, meaning that the frame part R₂ is directly accessible at the surface O_{A/MK}, such that it can be wetted at the surface O_{A/MK}, for example, with aqueous solution, alcoholic solution, alcohol or water.

What this means more particularly for the arrangement of the frame element R in the dividing wall W is that there is a route from the surface O_{KK} on the side S_{KK} to the surface O_{A/MK} on the side S_{A/MK} that leads through the R₁ part and then through the R₂ part (and possibly through a seal Di), but not through an ASC.

In a preferred embodiment of the dividing wall W in the first aspect of the invention, 50% to 95%, more preferably 60% to 90%, even more preferably 70% to 85%, of the surface O_{KK} is formed by the ASCs encompassed by the dividing wall W, with the rest of the surface O_{KK} even more preferably being formed by the frame part R₁.

In a preferred embodiment of the dividing wall W in the first aspect of the invention, 50% to 95%, more preferably 60% to 90%, even more preferably 70% to 85%, of the surface O_{A/MK} is also formed by the ASCs encompassed by the dividing wall W, with the rest of the surface O_{A/MK} even more preferably being formed by the frame part R₂.

In a preferred embodiment, the dividing wall W, especially between frame element R and the ASCs, comprises a seal Di (shown, for example, in FIGS. 3 A,3 B and 3 C). This ensures in a particularly efficient manner that the dividing wall W is liquid-tight. The seal Di may be selected by the person skilled in the art for the respective ASC or the respective frame element R.

The seal Di especially comprises a material selected from the group consisting of elastomers, adhesives, preferably elastomers.

A useful elastomer is especially rubber, preferably ethylene-propylene-diene rubber (“EPDM”), fluoropolymer rubber (“FPM”), perfluoropolymer rubber (“FFPM”), or acrylonitrile-butadiene rubber (“NBR”).

The seal Di is preferably selected such that it is compressed when the two frame parts R₁ and R₂ are secured to one another and the ASCs are arranged between the two frame parts R₁ and R₂. This further increases the integrity of the dividing wall W.

In a preferred embodiment, the dividing wall W comprises at least four ASCs F_{A}, F_{B}, F_{C} and F_{D}, and even more preferably comprises exactly four ASCs F_{A}, F_{B}, F_{C} and F_{D}.

In a further preferred embodiment, the dividing wall W comprises at least nine ASCs F_{A}, F_{B}, F_{C}, F_{D}, F_{E}, F_{F}, F_{G}, F_{H} and F_{I}, and even more preferably comprises exactly nine ASCs F_{A}, F_{B}, F_{C}, F_{D}, F_{E}, F_{F}, F_{G}, F_{H} and F_{I}.

In a further preferred embodiment, the dividing wall W comprises at least twelve ASCs F_{A}, F_{B}, F_{C}, F_{D}, F_{E}, F_{F}, F_{G}, F_{H}, F_{I}, F_{J}, F_{K} and F_{L}, and even more preferably comprises exactly twelve ASCs F_{A}, F_{B}, F_{C}, F_{D}, F_{E}, F_{F}, F_{G}, F_{H}, F_{I}, F_{J}, F_{K} and F_{L}.

This inventive arrangement of at least two ASCs alongside one another in the dividing wall W, compared to the conventional dividing walls in the prior art electrolysis cells, results in a further direction of spread for the ASCs in the event of the fluctuations in temperature that arise in the operation of the electrolysis cell. In the prior art electrolysis cells, the NaSICON sheets that function as dividing walls are framed by the outer walls of the electrolysis cell or by solid plastic frames. It is not possible in this way to dissipate the mechanical stresses that occur in the event of expansion within the NaSICON, which can lead to fracture of the ceramic.

By contrast, the individual ASCs within the dividing wall W in the first aspect of the invention adjoin the separating element R_{T}, and, in the case of the ASCs at the edge of the surfaces O_{KK} and O_{A/MK}, also adjoin the frame element R_{R}, which leads to advantageous effects, both of which increase the long-term stability of the ASC:
each ASC has a further available degree of freedom, i.e. a dimension in which it can expand. As well as expansion in z direction (i.e. beyond the thickness of the ceramic sheet at right angles to the plane of the dividing wall W), expansion in x and/or y direction is now also possible, i.e. in horizontal and vertical direction within the plane of the dividing wall W. This direction of expansion does not exist, or is at least greatly restricted, when the ASCs, for example as a solid sheet, span the cross section of the electrolysis cell and adjoin the solid wall of the electrolysis cell.
compared to a dividing wall of equal size consisting solely of one ASC, the division into multiple small ASCs has the effect that the stresses that occur within the smaller ASCs are also smaller in absolute terms, can be dissipated more rapidly and hence cannot as quickly build up to a stress that leads to the fracture of the ASC.

As a result, the tendency to fracture is distinctly reduced for the “divided” ASCs in the dividing wall W compared to the use of one sheet.

### 4.1.1 Frame Element R

The frame element R comprises two opposite parts R₁ and R₂, with the at least two alkali metal cation-conducting solid-state ceramics F_{A} and F_{B} encompassed by the dividing wall W disposed therebetween. This arrangement can be effected in any manner familiar to the person skilled in the art. In a particular embodiment, the two parts R₁ and R₂ clamp the ASCs between them, preferably using a seal Di that additionally stabilizes the ASCs in the frame element R. In another preferred embodiment, the ASCs are bonded to the two frame parts R₁ and R₂. Adhesives KI used for the purpose may be any of the adhesives familiar to the person skilled in the art that are stable under the conditions of the electrolysis. Preferred KIs include at least one substance selected from epoxy resins, phenolic resins.

The dividing wall W may have a hinge by which the two parts R₁ and R₂ of the frame element R can be opened and closed.

The frame element R especially comprises a material selected from the group consisting of plastic, glass, wood. More preferably, the frame element R comprises plastic.

Even more preferably, the plastic is one selected from the group consisting of polypropylene, polystyrene, polyvinylchloride.

In a preferred embodiment, a seal Di is provided between frame element R and the ASCs encompassed by the dividing wall W. This improves the liquid-tightness of the dividing wall W.

The frame element R forms an edge element R_{R} and a separating element R_{T}.

### 4.1.1.1 Separating Element R_{T}

Separating element R_{T} refers to that region of the frame element R that lies between at least two ASCs and separates these from one another. The separating element R_{T} as a region of the frame element R is formed by the two parts R₁ and R₂.

A suitable separating element R_{T} which is formed by the frame element R is any body by means of which the respective ASCs can be arranged separately from one another. The ASCs here gaplessly adjoin the separating element R_{T} in order not to impair the function of the dividing wall W which, in the electrolysis cell E, is to divide the cathode chamber in a liquid-tight manner from the adjacent middle chamber or anode chamber.

The shape of the separating element R_{T} can be chosen by the person skilled in the art, especially depending on the number and shape of the ASCs encompassed by the dividing wall W.

If the dividing wall W comprises two or three ASCs, for example, these may each be separated by a land disposed between the ASCs as a separating element R_{T} (see, for example, FIG. 2 A).

If the dividing wall W comprises four or more ASCs, these may be separated by a separating element R_{T} in the form of a cross (see FIGS. 2 B and 6 A) or grid (see FIG. 6 B).

It is preferable that the dividing wall W comprises at least four ASCs, and even more preferable that the separating element R_{T} is then in the form of a cross or grid, since all three dimensions are then fully available to the ASCs for thermal expansion/shrinkage.

The separating element R_{T} here is especially shaped in such a way that the respective ASC can be fitted or clamped into the separating element. This can already be implemented in a corresponding manner in the production of the dividing wall W.

The separating element R_{T} preferably comprises a material selected from the group consisting of plastic, glass, and wood. More preferably, the separating element R_{T} comprises plastic.

Even more preferably, the plastic is one selected from the group consisting of polypropylene, polystyrene, polyvinylchloride (“PVC”). PVC also includes post-chlorinated polyvinylchloride (“PVC-C”).

### 4.1.1.2 Edge Element R_{R}

The frame element R forms not only the separating element R_{T} but also an edge element R_{R}. The edge element R_{R} as a region of the frame element R is formed by the two parts R₁ and R₂. The edge element R_{R} (as distinct from the separating element R_{T}) is that region of the frame element R which is not disposed between the alkali metal cation-conducting solid-state electrolyte ceramics encompassed by the dividing wall W, i.e. does not separate these from one another.

The edge element R_{R} bounds the surfaces O_{KK} and O_{A/MK} at least partly, preferably completely. What this means is more particularly: The edge element R_{R} surrounds the surfaces O_{KK} and O_{A/MK} at least partly, preferably completely.

The edge element R_{R} here may or may not be part of the surfaces O_{KK} and O_{A/MK}. The edge element R_{R} is preferably part of the surfaces O_{KK} and O_{A/MK}.

The edge element R_{R} is especially directly contactable or not directly contactable via the surfaces O_{KK} and O_{A/MK}.

The edge element R_{R} is preferably directly contactable via the surfaces O_{KK} and O_{A/MK}. In this preferred embodiment, the edge element R_{R} as part of R₁ is directly contactable via the surface O_{KK}, and as part of R₂ is directly contactable via the surface O_{A/MK}.
What is meant by “not directly contactable” with regard to the edge element R_{R} encompassed by the dividing wall W is that the edge element R_{R} is formed exclusively as at least part of the surfaces of those sides of the dividing wall W which are not the sides S_{KK} and S_{A/MK}. More particularly, the edge element R_{R} in that case forms at least 1%, more preferably at least 25%, more preferably at least 50%, even more preferably 100%, of the surface areas of the sides of the dividing wall W that are not the sides S_{KK} and S_{A/MK}.
What is meant by “directly contactable” with regard to the frame element R_{R} encompassed by the dividing wall W is that part of the surface O_{KK} is formed by the surface of the frame element R_{R}, meaning that the frame element R_{R} is directly accessible at the surface O_{KK}, such that it can be wetted at the surface O_{KK}, for example, with aqueous solution, alcoholic solution, alcohol or water.
What is also meant by “directly contactable” with regard to the frame element R_{R} encompassed by the dividing wall W is that part of the surface O_{A/MK} is formed by the surface of the frame element R_{R}, meaning that the frame element R_{R} is directly accessible at the surface O_{A/MK}, such that it can be wetted at the surface O_{A/MK}, for example, with aqueous solution, alcoholic solution, alcohol or water. What this means for the arrangement of the edge element R_{R} in the dividing wall W is that there is a route from the surface O_{KK} on the side S_{KK} to the surface O_{A/MK} on the side SA/MK that leads completely through the edge element R_{R}.
This includes the following embodiments:
   a portion of the edge of the surfaces O_{KK} and O_{A/MK} is formed by the edge element R_{R}
   the edge of the surfaces O_{KK} and O_{A/MK} is formed completely by the edge element R_{R} (as shown in FIGS. 2 A, 2 B, 6 A, 6 B).
The edge element R_{R} here may additionally be formed as at least part of the surfaces of those sides of the dividing wall W that are not the sides S_{KK} and S_{A/MK}. More particularly, the edge element R_{R} forms at least 1%, more preferably at least 25%, more preferably at least 50%, even more preferably 100%, of the surface areas of the sides of the dividing wall W that are not the sides S_{KK} and S_{A/MK}.

FIG. 2 A and FIG. 2 B show, for example, embodiments in which the edge element R_{R} completely forms the surfaces of those sides of the dividing wall W which are not the sides S_{KK} and S_{A/MK}.

The edge element R_{R} preferably comprises a material selected from the group consisting of plastic, glass, wood. More preferably, the edge element R_{R} comprises plastic.

Even more preferably, the plastic is one selected from the group consisting of polypropylene, polystyrene, polyvinylchloride (“PVC”). PVC also includes post-chlorinated polyvinylchloride (“PVC-C”).

In a further preferred embodiment, the edge element R_{R} and the separating element R_{T} comprise the same material, and both even more preferably comprise plastic, which is even more preferably selected from polypropylene, polystyrene, polyvinylchloride, PVC-C.

In a preferred embodiment, at least part of the separating element R_{T} is formed in one piece with at least part of the frame element R_{R}. What this means more particularly is that at least part of the separating element R_{T} merges into the edge element R_{R}.

The embodiment of an edge element R_{R} has the further advantage that it functions as part of the outer wall in the electrolysis cell E. This part of the dividing wall W does not make contact with the solutions in the respective interior I_{KK}, I_{KA} or I_{KM}, and it would therefore be a waste to form this part of the dividing wall W with a solid-state electrolyte ceramic. In addition, the part of the dividing wall W which is clamped between the outer wall or forms part thereof is subjected to forces that the brittle solid-state electrolyte ceramic might not withstand. Instead, a fracture-resistant and cheaper material is thus selected for the frame element R.

4.1.2 Securing Elements B_{R} and B_{T}

The dividing wall W in the first aspect of the invention is characterized in that R₁ and R₂ are secured to one another by at least one securing element B_{R} at the edge element R_{R}, and R₁ and R₂ are secured to one another by at least one securing element B_{T} at the separating element R_{T}.

What is meant by “at the edge element R_{R}” in this context is “in the region of the edge element R_{R}”.

What is meant by “at the separating element R_{T}” in this context is “in the region of the separating element R_{T}”.

Suitable securing elements B_{R} and B_{T} are all means familiar to the person skilled in the art for securing the two frame parts R₁ and R₂ to one another.

These securing elements B_{R} and B_{T} are especially selected from hinges, clamps, nails, screws, hooks, preferably from screws, hooks, most preferably hooks.

The securing elements B_{R} and B_{T} may be made from a material familiar to the person skilled in the art.

They preferably comprise a material selected from the group consisting of plastic, glass, wood. Particular preference is given to plastic.

Even more preferably, the plastic is one selected from the group consisting of polypropylene, polystyrene, polyvinylchloride, PVC-C.

Even more preferably, the at least one securing element B_{R} and the at least one securing element B_{T} are each in the form of mutually engaging hooks B_{H}. In the state secured to one another, these hooks especially then span the dividing wall W.

For this purpose, as B_{T}, mutually opposing pairs of hooks B_{H} are advantageously each formed on the mutually facing sides of the two frame parts R₁ and R₂ in the region of the separating element R_{T}, and these engage with one another, preferably reversibly, on arrangement of the ASCs between the frame parts R₁ and R₂. It will be apparent that, for this embodiment, the edge element R_{R} must be directly contactable via the surfaces O_{KK} and O_{A/MK}.

For this purpose, as B_{R}, mutually opposing pairs of hooks B_{H} are advantageously each formed on the mutually facing sides of the two frame parts R₁ and R₂ in the region of the edge element R_{R}, and these engage reversibly with one another on arrangement of the ASCs between the frame parts R₁ and R₂.

“Mutually facing sides of the two frame parts R₁ and R₂” relates to the sides of the two frame parts the surface of which is not directly contactable via the surface O_{KK} in the case of R₁, and the surface of which is not directly contactable via the surface O_{A/MK} in the case of R₂. These are especially the surfaces R₁ and R₂ that make contact with the ASCs and/or the seal Di in the dividing wall W.

The securing means B_{R} and B_{T}, especially the hooks, are preferably in one-piece form with at least one of the parts R₁ and R₂ (FIG. 3 B).

In another preferred embodiment, the at least one securing element B_{R} and the at least one securing element B_{T} are each in the form of mutually engaging hooks B_{H}.

In a preferred embodiment, hooks B_{H} are formed on both frame parts R₁ and R₂ in the region of the separating element R_{T} and in the region of the edge element R_{R} in such a way that they engage when the ASCs are arranged between the frame parts R₁ and R₂ and hence secure the frame parts R₁ and R₂ to one another. Even more preferably, this is reversible, meaning that the hooks B_{H} can be detached from one another. This can be achieved, for example, in that the hooks are designed so as to be movable with respect to one another.

The mounting of the securing means B_{R} and B_{T} both on the edge element R_{R} and on the separating element R_{T} surprisingly improves the stability of the dividing wall W. The use of securing means in the region not just of the edge element R_{R} but also of the separating element R_{T} makes it possible to introduce compression forces not just at the outer corners but over the entire area of the frame element R.

### 4.1.3 Alkali Metal Cation-Conducting Solid-State Electrolyte Ceramic (“ASC”)

A useful alkali metal cation-conducting solid-state electrolyte ceramic F_{A}, F_{B} etc. encompassed by the dividing wall W is any solid-state electrolyte through which cations, especially alkali metal cations, even more preferably sodium cations, can be transported from the S_{A/MK} side to the S_{KK} side. Such solid-state electrolytes are known to the person skilled in the art and are described, for example, in DE 10 2015 013 155 A1, in WO 2012/048032 A2, paragraphs [0035], [0039], [0040], in US 2010/0044242 A1, paragraphs [0040], [0041], in DE 10360758 A1, paragraphs [014] to [025]. They are sold commercially under the NaSICON, LiSICON, KSICON name. A sodium ion-conducting solid-state electrolyte is preferred, and this even more preferably has an NaSICON structure. NaSICON structures usable in accordance with the invention are also described, for example, by N. Anantharamulu, K. Koteswara Rao, G. Rambabu, B. Vijaya Kumar, Velchuri Radha, M. Vithal, J Mater Sci 2011, 46, 2821-2837.

In a preferred embodiment of the dividing wall W, the alkali metal cation-conducting solid-state ceramics encompassed by the dividing wall W independently have an NaSICON structure of the FORMULA M^{I}_{1+2w+x-y+z} M^{II}_{w} M^{III}ₓ ZR^{IV}_{2-w-x-y} M^{V}_{Y} (SiO₄)_{z} (PO₄)_{3-z}.
M^{I} here is selected from Na⁺, Li⁺, preferably Na⁺.
M^{II} here is a divalent metal cation, preferably selected from Mg²⁺, Ca²⁺, Sr²⁺, Ba²⁺, CO²⁺, Ni²⁺, more preferably selected from CO²⁺Ni²⁺.
M^{III} here is a trivalent metal cation, preferably selected from Al³⁺, Ga³⁺, Sc³⁺, La³⁺, Y³⁺, Gd³⁺, Sm³⁺, Lu³⁺, Fe³⁺, Cr³⁺, more preferably selected from Sc³⁺, La³⁺, Y³⁺, Gd³⁺, Sm³⁺, especially preferably selected from Sc³⁺, Y³⁺, La³⁺.
M^{V} here is a pentavalent metal cation, preferably selected from V⁵⁺, Nb⁵⁺, Ta⁵⁺.

The Roman indices I, II, III, IV, V indicate the oxidation numbers in which the respective metal cations exist.
w, x, y, z are real numbers, where 0≤x<2, 0≤y<2, 0≤w<2, 0≤z<3,
and where w, x, y, z are chosen such that 1+2w+x−y+z≥0 and 2−w−x−y≥0.

Even more preferably in accordance with the invention, the NaSICON structure has a structure of the formula Na₍₁₊ᵥ₎Zr₂SiᵥP₍₃₋ᵥ₎O₁₂ where v is a real number for which 0 ≤v≤3. Most preferably, v=2.4.

In a preferred embodiment of the dividing wall W according to the first aspect of the invention, the ASCs encompassed by the dividing wall W have the same structure.

### 4.1.4 Production of the Dividing Wall W

The dividing wall W can be produced by methods known to the person skilled in the art.

For example, the ASCs encompassed by the dividing wall W may be inserted into an appropriate casting mould, optionally with seals, and the frame element R may be cast by means of liquid plastic and then left to solidify (injection-moulding method). In the course of solidification, this then surrounds the ASCs. The securing elements B_{T} and B_{R} may be provided in one casting by a suitable shape on the frame element R (and are then in one-piece form therewith). In this embodiment, mutually engaging hooks B_{H} in particular are suitable as securing means.

Alternatively, the frame element R or the frame parts R₁ and R₂ are cast separately. The securing elements B_{T} and B_{R} may be provided in one casting by a suitable shape on the frame element R (and are then in one-piece form therewith). In this embodiment, mutually engaging hooks B_{H} in particular are suitable as securing means.

Alternatively, the ASCs, optionally with the seal Di, can be arranged between the frame parts R₁ and R₂, and then the securing elements B_{T} and B_{R} can be attached. Suitable examples for this purpose are screws or nails that are driven through suitable cutouts in the frame parts R₁ and R₂ and secure these to one another.

### 4.2 Electrolysis Cell E

The dividing wall W in the first aspect of the invention is suitable as a dividing wall in an electrolysis cell E.

In a second aspect, the present invention therefore relates to an electrolysis cell E comprising
at least one anode chamber K_{A} having at least one inlet Z_{KA}, at least one outlet A_{KA}, and an interior I_{KA} comprising an anodic electrode E_{A},
at least one cathode chamber K_{K} having at least one inlet Z_{KK}, at least one outlet A_{KK}, and an interior I_{KK} comprising a cathodic electrode E_{K},
and optionally at least one interposed middle chamber K_{M} having at least one inlet Z_{KM}, at least one outlet A_{KM} and an interior I_{KM},
where I_{KA} and I_{KM} are then divided from one another by a diffusion barrier D, and A_{KM} is connected by a connection V_{AM} to the inlet Z_{KA}, such that liquid can be passed from I_{KM} into I_{KA} via the connection V_{AM},
   where
in the cases in which the electrolysis cell E does not comprise a middle chamber K_{M}, I_{KA} and I_{KK} are divided from one another by a dividing wall W according to the first aspect of the invention,
in the cases in which the electrolysis cell E comprises at least one middle chamber K_{M}, I_{KK} and I_{KM} are divided from one another by a dividing wall W according to the first aspect of the invention,
   characterized in that
   the alkali metal cation-conducting solid-state ceramics encompassed by the dividing wall W, and especially also the separating element R_{T}, directly contact the interior I_{KK} on the side S_{KK} via the surface O_{KK},
   and
in the cases in which the electrolysis cell E does not comprise a middle chamber K_{M}, the alkali metal cation-conducting solid-state ceramics encompassed by the dividing wall W, and especially also the frame element R, directly contact the interior I_{KA} on the side S_{A/MK} via the surface O_{A/MK},
in the cases in which the electrolysis cell E comprise at least one middle chamber K_{M}, the alkali metal cation-conducting solid-state ceramics encompassed by the dividing wall W, and especially also the frame element R, directly contact the interior I_{KM} on the side S_{A/MK} via the surface O_{A/MK}.

The electrolysis cell E in the second aspect of the invention comprises at least one anode chamber K_{A} and at least one cathode chamber K_{K}, and optionally at least one interposed middle chamber K_{M}. This also includes electrolysis cells E having more than one anode chamber K_{A} and/or cathode chamber K_{K} and/or middle chamber K_{M}. Such electrolysis cells in which these chambers are joined to one another in the form of modules are described, for example, in DD 258 143 A3 and US 2006/0226022 A1.

The electrolysis cell E in the second aspect of the invention, in a preferred embodiment, comprises an anode chamber K_{A} and a cathode chamber K_{K}, and optionally an interposed middle chamber K_{M}.

The electrolysis cell E typically has an outer wall W_{A}. The outer wall W_{A} is especially made from a material selected from the group consisting of steel, preferably rubberized steel, plastic, especially from Telene® (thermoset polydicyclopentadiene), PVC (polyvinylchloride), PVC-C (post-chlorinated polyvinylchloride), PVDF (polyvinylidenefluoride). W_{A} may especially be perforated for inlets and outlets. Within W_{A} are then the at least one anode chamber K_{A}, the at least one cathode chamber K_{K} and, In the embodiments in which the electrolysis cell E comprises one, the at least one interposed middle chamber K_{M}.

### 4.2.1 Cathode Chamber K_{K}

The cathode chamber K_{K} has at least one inlet Z_{KK}, at least one outlet A_{KK}, and an interior I_{KK} comprising a cathodic electrode E_{K}.

The interior I_{KK} of the cathode chamber K_{K} is divided from the interior I_{KA} of the anode chamber K_{A} by the dividing wall W in the first aspect of the invention, if the electrolysis cell E does not comprise a middle chamber K_{M}. The interior I_{KK} of the cathode chamber K_{K} is divided from the interior I_{KM} of the middle chamber K_{M} by the dividing wall W in the first aspect of the invention, if the electrolysis cell E comprises at least one middle chamber K_{M}.

### 4.2.1.1 Cathodic Electrode E_{K}

The cathode chamber K_{K} comprises an interior I_{KK} which in turn comprises a cathodic electrode E_{K}. A useful cathodic electrode E_{K} of this kind is any electrode familiar to the person skilled in the art that is stable under the conditions of the process according to the invention in the third aspect of the invention. These are described, in particular, in WO 2014/008410 A1, paragraph [025] or DE 10360758 A1, paragraph [030]. This electrode E_{K} may be selected from the group consisting of mesh wool, three-dimensional matrix structure and “balls”. The cathodic electrode E_{K} especially comprises a material selected from the group consisting of steel, nickel, copper, platinum, platinized metals, palladium, carbon-supported palladium, titanium. Preferably, E_{K} comprises nickel.

In the embodiments of the electrolysis cell E according to the second aspect of the invention in which it comprises a middle chamber K_{M}, this is between the anode chamber K_{A} and the cathode chamber K_{K}.

4.2.1.2 Inlet Z_{KK} and Outlet A_{KK} The cathode chamber K_{K} also encompasses an inlet Z_{KK} and an outlet A_{KK}. This enables addition of liquid, for example the solution L₂, to the interior I_{KK} of the cathode chamber K_{K}, and removal of liquid present therein, for example the solution L₁. The inlet Z_{KK} and the outlet A_{KK} are attached here to the cathode chamber K_{K} in such a way that the liquid comes into contact with the cathodic electrode E_{K} as it flows through the interior I_{KK} of the cathode chamber K_{K}. This is the prerequisite for the solution L₁ to be obtained at the outlet A_{KK} in the performance of the process according to the invention in the third aspect of the invention when the solution L₂ of an alkali metal alkoxide XOR in the alcohol ROH is routed through the interior I_{KK} of the cathode chamber K_{K}.

The inlet Z_{KK} and the outlet A_{KK} may be attached to the electrolysis cell E by methods known to the person skilled in the art, for example by means of holes in the outer wall and corresponding connections (valves) that simplify the introduction and discharge of liquid.

### 4.2.2 Anode Chamber K_{A}

The anode chamber K_{A} has at least one inlet Z_{KA}, at least one outlet A_{KA}, and an interior I_{KA} comprising an anodic electrode E_{A}.

The interior I_{KA} of the anode chamber K_{A}, if the electrolysis cell E comprises a middle chamber K_{M}, is divided from the interior I_{KM} of the middle chamber K_{M} by a diffusion barrier D.

If electrolysis cell E does not comprise a middle chamber K_{M}, the interior I_{KA} of the anode chamber K is divided from the interior I_{KK} of the cathode chamber K_{K} by the dividing wall W.

### 4.2.2.1 Anodic Electrode E_{A}

The anode chamber K_{A} comprises an interior I_{KA} which in turn comprises an anodic electrode E_{A}. A useful anodic electrode E_{A} of this kind is any electrode familiar to the person skilled in the art that is stable under the conditions of the process according to the invention in the third aspect of the invention. These are described, in particular, in WO 2014/008410 A1, paragraph [024] or DE 10360758 A1, paragraph [031]. This electrode E_{A} may consist of one layer or consist of multiple planar layers parallel to one another that may each be perforated or expanded. The anodic electrode E_{A} especially comprises a material selected from the group consisting of ruthenium oxide, iridium oxide, nickel, cobalt, nickel tungstate, nickel titanate, precious metals such as, in particular, platinum, supported on a support such as titanium or Kovar® (an iron/nickel/cobalt alloy in which the individual components are preferably as follows: 54% by mass of iron, 29% by mass of nickel, 17% by mass of cobalt). Further possible anode materials are especially stainless steel, lead, graphite, tungsten carbide, titanium diboride. Preferably, the anodic electrode E_{A} comprises a titanium anode coated with ruthenium oxide/iridium oxide (RuO₂+IrO₂/Ti).

4.2.2.2 Inlet Z_{KA} and Outlet A_{KA}

The anode chamber K_{K} also encompasses an inlet Z_{KA} and an outlet A_{KA}. This enables addition of liquid, for example the solution L₃, to the interior I_{KA} of the cathode chamber K_{A}, and removal of liquid present therein, for example the solution L₄. The inlet Z_{KA} and the outlet A_{KA} are attached here to the anode chamber K_{A} in such a way that the liquid comes into contact with the anodic electrode E_{A} as it flows through the interior I_{KA} of the anode chamber K_{A}. This is a prerequisite for the solution L₄ to be obtained at the outlet A_{KA} in the performance of the process according to the invention in the third aspect of the invention when the solution L₃ of a salt S is routed through the interior I_{KA} of the cathode chamber K_{A}.

The inlet Z_{KA} and the outlet A_{KA} may be attached to the electrolysis cell E by methods known to the person skilled in the art, for example by means of holes in the outer wall and corresponding connections (valves) that simplify the introduction and discharge of liquid. The inlet Z_{KA}, in particular embodiments in which the electrolysis cell E comprises a middle chamber K_{M}, may also be within the electrolysis cell, for example in the form of a perforation in the diffusion barrier D.

### 4.2.3 Optional Middle Chamber K_{M}

The electrolysis cell E in the second aspect of the invention preferably has a middle chamber K_{M}. The optional middle chamber K_{M} lies between cathode chamber and K_{K} anode chamber K_{A}. It comprises at least one inlet Z_{KM}, at least one outlet A_{KM} and an interior I_{KM}.

The interior I_{KA} of the anode chamber K_{A}, if the electrolysis cell E comprises a middle chamber K_{M}, is divided from the interior I_{KM} of the middle chamber K_{M} by a diffusion barrier D. A_{KM} is then also connected to the inlet Z_{KA} by a connection V_{AM}, such that liquid can be guided from I_{KM} into I_{KA} through the connection V_{AM}.

### 4.2.3.1 Diffusion Barrier D

The interior I_{KM} of the optional middle chamber K_{M} is divided from the interior I_{KA} of the anode chamber K_{A} by a diffusion barrier D and divided from the interior I_{KK} of the cathode chamber K_{K} by the dividing wall W.

The material used for the diffusion barrier D may be any which is stable under the conditions of the process according to the invention in the third aspect of the invention and prevents or slows the transfer of protons from the liquid present in the interior I_{KA} of the anode chamber K_{A} to the interior I_{KM} of the optional middle chamber K_{M}.

The diffusion barrier D used is especially a non-ion-specific dividing wall or a membrane permeable to specific ions. The diffusion barrier D is preferably a non-ion-specific dividing wall.

The material of the non-ion-specific dividing wall is especially selected from the group consisting of fabric, which is especially textile fabric or metal weave, glass, which is especially sintered glass or glass frits, ceramic, especially ceramic frits, membrane diaphragms, and is more preferably a textile fabric or metal weave, especially preferably a textile fabric. The textile fabric preferably comprises plastic, more preferably a plastic selected from PVC, PVC-C, polyvinylether (“PVE”), polytetrafluoroethylene (“PTFE”).

If the diffusion barrier D is a “membrane permeable to specific ions”, what this means in accordance with the invention is that the respective membrane promotes the diffusion of particular ions therethrough over other ions. More particularly, what this means is membranes that promote the diffusion therethrough of ions of a particular charge type over ions of the opposite charge. Even more preferably, membranes permeable to specific ions also promote the diffusion of particular ions of one charge type over other ions of the same charge type therethrough.

If the diffusion barrier D is a “membrane permeable to specific ions”, the diffusion barrier D is especially an anion-conducting membrane or a cation-conducting membrane.

According to the invention, anion-conducting membranes are those that selectively conduct anions, preferably selectively conduct particular anions. In other words, they promote the diffusion of anions therethrough over that of cations, especially over protons; even more preferably, they additionally promote the diffusion of particular anions therethrough over the diffusion of other anions therethrough.

According to the invention, cation-conducting membranes are those that selectively conduct cations, preferably selectively conduct particular cations. In other words, they promote the diffusion of cations therethrough over that of anions; even more preferably, they additionally promote the diffusion of particular cations therethrough over the diffusion of other cations therethrough, more preferably still that of cations that are not protons, more preferably sodium cations, over protons.

What is meant more particularly by “promote the diffusion of particular ions X over the diffusion of other ions Y” is that the coefficient of diffusion (unit: m²/s) of ion type X at a given temperature for the membrane in question is higher by a factor of 10, preferably 100, preferably 1000, than the coefficient of diffusion of ion type Y for the membrane in question.

If the diffusion barrier D is a “membrane permeable to specific ions”, it is preferably an anion-conducting membrane since this particularly efficiently prevents the diffusion of protons from the anode chamber K_{A} into the middle chamber K_{M}.

The anion-conducting membrane used is especially one selective for the anions encompassed by the salt S. Such membranes are known to and can be used by the person skilled in the art.

The salt S is preferably a halide, sulfate, sulfite, nitrate, hydrogencarbonate or carbonate of X, even more preferably a halide.

Halides are fluorides, chlorides, bromides, iodides. The most preferred halide is chloride.

The anion-conducting membrane used is preferably one selective for halides, preferably chloride.

Anion-conducting membranes are described, for example, by M. A. Hickner, A. M. Herring, E. B. Coughlin, Journal of Polymer Science, Part B: Polymer Physics 2013, 51, 1727-1735, by C. G. Arges, V. Ramani, P. N. Pintauro, Electrochemical Society Interface 2010, 19, 31-35, in WO 2007/048712 A2, and on page 181 of the textbook by Volkmar M. Schmidt, Elektrochemische Verfahrenstechnik: Grundlagen, Reaktionstechnik, Prozessoptimierung [Electrochemical Engineering: Fundamentals, Reaction Technology, Process Optimization], 1st edition (8 Oct. 2003).

Even more preferably, anion-conducting membranes used are accordingly organic polymers that are especially selected from polyethylene, polybenzimidazoles, polyether ketones, polystyrene, polypropylene and fluorinated membranes such as polyperfluoroethylene, preferably polystyrene, where these have covalently bonded functional groups selected from —NH₃⁺, —NRH₂⁺, —NR₃⁺, ═NR⁺; —PR₃⁺, where R is alkyl groups having preferably 1 to 20 carbon atoms, or other cationic groups. They preferably have covalently bonded functional groups selected from —NH₃⁺, —NRH₂⁺ and —NR₃⁺, more preferably selected from —NH₃⁺ and —NR₃⁺, even more preferably —NR₃⁺.

If the diffusion barrier D is a cation-conducting membrane, it is especially a membrane selective for the cations encompassed by the salt S. Even more preferably, the diffusion barrier D is an alkali metal cation-conducting membrane, even more preferably a potassium and/or sodium ion-conducting membrane, most preferably a sodium ion-conducting membrane.

Cation-conducting membranes are described, for example, on page 181 of the textbook by Volkmar M. Schmidt, Elektrochemische Verfahrenstechnik: Grundlagen, Reaktionstechnik, Prozessoptimierung, 1st edition (8 Oct. 2003).

Even more preferably, cation-conducting membranes used are accordingly organic polymers that are especially selected from polyethylene, polybenzimidazoles, polyether ketones, polystyrene, polypropylene and fluorinated membranes such as polyperfluoroethylene, preferably polystyrene and polyperfluoroethylene, where these bear covalently bonded functional groups selected from —SO₃⁻, —COO⁻, —PO₃²⁻ and —PO₂H⁻, preferably —SO₃⁻ (described in DE 10 2010 062 804 A1, U.S. Pat. No. 4,831,146).

This may be, for example, a sulfonated polyperfluoroethylene (Nafion® with CAS number: 31175-20-9). These are known to the person skilled in the art, for example from WO 2008/076327 A1, paragraph [058], US 2010/0044242 A1, paragraph [0042] or US 2016/0204459 A1, and are commercially available under the Nafion®, Aciplex® F, Flemion®, Neosepta®, Ultrex®, PC—SK® trade names. Neosepta® membranes are described, for example, by S. A. Mareev, D. Yu. Butylskii, N. D. Pismenskaya, C. Larchet, L. Dammak, V. V. Nikonenko, Journal of Membrane Science 2018, 563, 768-776.

If a cation-conducting membrane is used as diffusion barrier D, this may, for example, be a polymer functionalized with sulfonic acid groups, especially of the formula P_{NAFION} below, where n and m may independently be a whole number from 1 to 10⁶, preferably a whole number from 10 to 105, more preferably a whole number from 10² to 10⁴.

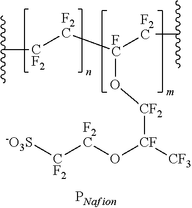

4.2.3.2 Inlet Z_{KM} and Outlet A_{KM}

The optional middle chamber K_{M} also encompasses an inlet Z_{KM} and an outlet A_{KM}. This enables addition of liquid, for example the solution L₃, to the interior I_{KM} of the middle chamber K_{M}, and transfer of liquid present therein, for example the solution L₃, to the anode chamber K_{A}.

The inlet Z_{KM} and the outlet A_{KM} may be attached to the electrolysis cell E by methods known to the person skilled in the art, for example by means of holes in the outer wall and corresponding connections (valves) that simplify the introduction and discharge of liquid. The outlet A_{KM} may also be within the electrolysis cell, for example in the form of a perforation in the diffusion barrier D.

### 4.2.3.3 Connection V_{AM}

In the electrolysis cell E according to the second aspect of the invention, the outlet A_{KM} is connected to the inlet Z_{KA} by a connection V_{AM} in such a way that liquid can be guided from I_{KM} into I_{KA} through the connection V_{AM}.

The connection V_{AM} may be formed within the electrolysis cell E and/or outside the electrolysis cell E, and is preferably formed within the electrolysis cell.

1) If the connection V_{AM} is formed within the electrolysis cell E, it is preferably formed by at least one perforation in the diffusion barrier D. This embodiment is preferred especially when the diffusion barrier D used is a non-ion-specific dividing wall, especially a metal weave or textile fabric. This functions as a diffusion barrier D and, on account of the weave properties, has perforations and gaps from the outset that function as connection V_{AM}.

2) The embodiment described hereinafter is preferred especially when the diffusion barrier D used is a membrane permeable to specific ions: In this embodiment, the connection V_{AM} is formed outside the electrolysis cell E, preferably formed by a connection of A_{KM} and Z_{KA} that runs outside the electrolysis cell E, especially in that an outlet A_{KM} through the outer wall W_{A} is formed from the interior of the middle chamber I_{KM}, preferably at the base of the middle chamber K_{M}, the inlet Z_{KM} more preferably being at the top end of the middle chamber K_{M}, and an inlet Z_{KA} through the outer wall W_{A} is formed in the interior I_{KA} of the anode chamber K_{A}, preferably at the base of the anode chamber K_{A}, and these are connected by a conduit, for example a pipe or a hose, preferably comprising a material selected from rubber and plastic. The outlet A_{KA} is then more preferably at the top end of the anode chamber K_{A}.

“Outlet A_{KM} at the base of the middle chamber K_{M}” means that the outlet A_{KM} is attached to the electrolysis cell E in such a way that the solution L₃ leaves the middle chamber K_{M} in the direction of gravity.

“Inlet Z_{KA} at the base of the anode chamber K_{A}” means that the inlet Z_{KA} is attached to the electrolysis cell E in such a way that the solution L₃ enters the anode chamber K_{A} counter to gravity.

“Inlet Z_{KM} at the top end of the middle chamber K_{M}” means that the inlet Z_{KM} is attached to the electrolysis cell E in such a way that the solution L₃ enters the middle chamber K_{M} in the direction of gravity.

“Outlet A_{KA} at the top end of the anode chamber K_{A}” means that the outlet A_{KA} is mounted on the electrolysis cell E in such a way that the solution L₄ leaves the anode chamber K_{A} counter to gravity.

This embodiment is particularly advantageous and therefore preferred when the outlet A_{KM} is formed by the outer wall W_{A} at the base of the middle chamber K_{M}, and the inlet Z_{KA} by the outer wall W_{A} at the base of the anode chamber K_{A}. This arrangement makes it possible in a particularly simple manner to remove gases formed in the anode chamber K_{A} from the anode chamber K_{A} with L₄, in order to separate them further.

When the connection V_{AM} is formed outside the electrolysis cell E, Z_{KM} and A_{KM} are especially arranged at opposite ends of the outer wall W_{A} of the middle chamber K_{M} (i.e., for example, Z_{KM} at the base and A_{KM} at the top end of the electrolysis cell E or vice versa) and Z_{KA} and A_{KA} are arranged at opposite ends of the outer wall W_{A} of the anode chamber K_{A} (i.e. Z_{KA} at the base and A_{KA} at the top end of the electrolysis cell E or vice versa), as shown more particularly in FIG. 5 A. By virtue of this geometry, L₃ must flow through the two chambers K_{M} and K_{A}. It is possible here for Z_{KA} and Z_{KM} to be formed on the same side of the electrolysis cell E, in which case A_{KM} and A_{KA} are automatically also formed on the same side of the electrolysis cell E. Alternatively, Z_{KA} and Z_{KM} may be formed on opposite sides of the electrolysis cell E, in which case A_{KM} and A_{KA} are then automatically also formed on opposite sides of the electrolysis cell E.

3) When the connection V_{AM} is formed within the electrolysis cell E, this may especially be ensured in that one side (“side A”) of the electrolysis cell E, which is the top end or the base of the electrolysis cell E, preferably the top end as shown in FIG. 5 B, comprises the inlet Z_{KM} and the outlet A_{KA}, and the diffusion barrier D extends proceeding from this side (“side A”) into the electrolysis cell E, but does not quite reach up to the side (“side B”) of the electrolysis cell E opposite side A, which is then the base or the top end of the electrolysis cell E, and at the same time covers 50% or more of the height of the three-chamber cell E, preferably 60% to 99% of the height of the three-chamber cell E, more preferably 70% to 95% of the height of the three-chamber cell E, even more preferably 80% to 90% of the height of the three-chamber cell E, more preferably still 85% of the height of the three-chamber cell E. Because the diffusion barrier D does not touch side B of the three-chamber cell E, a gap thus arises between diffusion barrier D and the outer wall W_{A} of side B of the three-chamber cell E. In that case, the gap is the connection V_{AM}. By virtue of this geometry, L₃ must flow completely through the two chambers K_{M} and K_{A}.

These embodiments best ensure that the aqueous salt solution L₃ flows past the acid-sensitive solid-state electrolyte before it comes into contact with the anodic electrode E_{A}, which results in the formation of acids.

According to the invention, “base of the electrolysis cell E” is the side of the electrolysis cell E through which a solution (e.g. LU in the case of A_{KM} in FIG. 5 A) exits from the electrolysis cell E in the same direction as gravity, or the side of the electrolysis cell E through which a solution (e.g. L₂ in the case of Z_{KK} in FIGS. 5 A and 5 B and L₃ in the case of A_{KA} in FIGS. 4 A and 4 B) is supplied to the electrolysis cell E counter to gravity.

According to the invention, “top end of the electrolysis cell E” is the side of the electrolysis cell E through which a solution (e.g. L₄ in the case of A_{KA} and L₁ in the case of A_{KK} in FIGS. 5 A and 5 B) exits from the electrolysis cell E counter to gravity, or the side of the electrolysis cell E through which a solution (e.g. L in the case of Z_{KM} in FIGS. 5 A and 5 B) is supplied to the electrolysis cell E in the same direction as gravity.

### 4.2.4 Arrangement of the Dividing Wall W in the Electrolysis Cell E

The dividing wall W is arranged in the electrolysis cell E in such a way that the alkali metal cation-conducting solid-state electrolyte ceramics encompassed by the dividing wall W, and preferably also the frame element R, directly contact the interior I_{KK} on the side S_{KK} via the surface O_{KK}.

This means that the dividing wall W is arranged within the electrolysis cell E such that, when the interior I_{KK} on the side S_{KK} side is completely filled with solution L₄, the solution L₄, via the surface O_{KK}, then makes contact with all alkali metal cation-conducting solid-state electrolyte ceramics encompassed by the dividing wall W, and preferably also the frame element R via part R₁, such that ions (e.g. alkali metal ions such as sodium, lithium) from all ASCs encompassed by the dividing wall W can enter the solution L₄.

In addition, the dividing wall W, in the embodiments in which the electrolysis cell E does not comprise a middle chamber K_{M}, is arranged in the electrolysis cell E such that the alkali metal cation-conducting solid-state electrolyte ceramics encompassed by the dividing wall W, and preferably also the frame element R, make direct contact with the interior I_{KA} on the side S_{A/MK} via the surface O_{A/MK}.

What this means is as follows: in the embodiments in which the electrolysis cell E does not comprise a middle chamber K_{M}, the dividing wall W adjoins the interior I_{KA} of the anode chamber K_{A}. In these embodiments, the dividing wall W is arranged within the electrolysis cell E such that, when the interior I_{KA} on the side S_{AM/K} is completely filled with solution L₃, the solution L₃, via the surface O_{A/MK}, then makes contact with all alkali metal cation-conducting solid-state electrolyte ceramics encompassed by the dividing wall W, and preferably also the frame element R via part R₂, such that ions (e.g. alkali metal ions such as sodium, lithium) from the solution L₃ can enter any ASC encompassed by the dividing wall W.

In addition, the dividing wall W, in the cases in which the electrolysis cell E comprises at least one middle chamber K_{M}, is arranged in the electrolysis cell E such that the alkali metal cation-conducting solid-state electrolyte ceramics encompassed by the dividing wall W, and especially also the frame element R, make direct contact with the interior I_{KM} on the side S_{A/MK} via the surface O_{A/MK}.

What this means is as follows: in the embodiments in which the electrolysis cell E comprises at least one middle chamber K_{M}, the dividing wall W adjoins the interior I_{KM} of the middle chamber K_{M}. In these embodiments, the dividing wall W is arranged within the electrolysis cell E such that, when the interior I_{KM} on the side S_{AM/K} is completely filled with solution L₃, the solution L₃, via the surface O_{A/MK}, then makes contact with all alkali metal cation-conducting solid-state electrolyte ceramics encompassed by the dividing wall W, and preferably also the frame element R via part R₂, such that ions (e.g. alkali metal ions such as sodium, lithium) from the solution L₃ can enter any ASC encompassed by the dividing wall W.

In a preferred embodiment of the electrolysis cell E in the second aspect of the invention, at least 50%, especially at least 70%, preferably at least 90%, most preferably 100%, of the portion of the surface O_{KK} which is formed by ASCs makes contact with the interior I_{KK}.

In a preferred embodiment of the electrolysis cell E without a middle chamber in the second aspect of the invention, at least 50%, especially at least 70%, preferably at least 90%, most preferably 100%, of the portion of the surface O_{A/MK} which is formed by ASCs makes contact with the interior I_{KA}.

In a preferred embodiment of the electrolysis cell E with at least one middle chamber in the second aspect of the invention, at least 50%, especially at least 70%, preferably at least 90%, most preferably 100%, of the portion of the surface O_{A/MK} which is formed by ASCs makes contact with the interior I_{KM}.

### 4.3 Process According to the Invention

The present invention relates, in a third aspect, to a process for producing a solution L₁ of an alkali metal alkoxide XOR in the alcohol ROH, where X is an alkali metal cation and R is an alkyl radical having 1 to 4 carbon atoms. The process according to the third aspect of the invention is conducted in an electrolysis cell E in the second aspect of the invention.

X is preferably selected from the group consisting of Li⁺, K⁺, Na⁺, more preferably from the group consisting of K⁺, Na⁺. Most preferably, X=Na⁺.

R is preferably selected from the group consisting of n-propyl, iso-propyl, ethyl and methyl, more preferably from the group consisting of ethyl and methyl. R is most preferably methyl. 4.3.1 Process according to the invention in an electrolysis cell E without a middle chamber K_{M}In the cases in which the electrolysis cell E does not comprise a middle chamber K_{M}, the steps (α1), (α2), (α3) that proceed simultaneously are conducted.

### 4.3.1.1 Step (α1)

In step (α1), a solution L₂ comprising the alcohol ROH, preferably comprising an alkali metal alkoxide XOR and alcohol ROH, is routed through K_{K}.

Solution L₂ is preferably free of water. What is meant in accordance with the invention by “free of water” is that the weight of water in solution L₂ based on the weight of the alcohol ROH in solution L₂ (mass ratio) is ≤1:10, more preferably ≤1:20, even more preferably ≤1:100, even more preferably ≤0.5:100.

If solution L₂ comprises XOR, the proportion by mass of XOR in solution L₂, based on the overall solution L₂, is especially >0% to 30% by weight, preferably 5% to 20% by weight, more preferably 10% to 20% by weight, more preferably 10% to 15% by weight, most preferably 13% to 14% by weight, at the very most preferably 13% by weight.

If solution L₂ comprises XOR, the mass ratio of XOR to alcohol ROH in solution L₂ is especially in the range of 1:100 to 1:5, more preferably in the range of 1:25 to 3:20, even more preferably in the range of 1:12 to 1:8, even more preferably 1:10.

### 4.3.1.2 Step (α2)

In step (α2), a neutral or alkaline, aqueous solution L₃ of a salt S comprising X as cation is routed through K_{A}.

The salt S is preferably a halide, sulfate, sulfite, nitrate, hydrogencarbonate or carbonate of X, even more preferably a halide.

Halides are fluorides, chlorides, bromides, iodides. The most preferred halide is chloride.

The pH of the aqueous solution L₃ is >7.0, preferably in the range of 7 to 12, more preferably in the range of 8 to 11, even more preferably 10 to 11, most preferably 10.5.

The proportion by mass of salt S in solution L₃ is preferably in the range of >0% to 20% by weight, preferably 1% to 20% by weight, more preferably 5% to 20% by weight, even more preferably 10% to 20% by weight, most preferably 20% by weight, based on the overall solution L₃.

### 4.3.1.3 Step (α3)

In step (α3), a voltage is then applied between E_{A} and E_{K}.

This results in transfer of current from the charge source to the anode, transfer of charge via ions to the cathode and ultimately transfer of current back to the charge source. The charge source is known to the person skilled in the art and is typically a rectifier that converts alternating current to direct current and can generate particular voltages via voltage transformers.

This in turn has the following consequences:
the solution L₁ is obtained at the outlet A_{KK} with a higher concentration of XOR in L₁ than in L₂,
an aqueous solution L₄ of S is obtained at the outlet A_{KA}, with a lower concentration of S in L₄ than in L₃.

In step (α3) of the process according to the third aspect the invention, in particular, such a voltage is applied that such a current flows such that the current density (=ratio of the current supplied to the electrolysis cell to the area of the solid-state electrolyte in contact with the anolyte present in the anode chamber K_{A}) is in the range from 10 to 8000 Nm², more preferably in the range from 100 to 2000 Nm², even more preferably in the range from 300 to 800 Nm², and even more preferably is 494 Nm². This can be determined in a standard manner by the person skilled in the art. The area of the solid-state electrolyte in contact with the anolyte present in the anode chamber K_{A} is especially 0.00001 to 10 m², preferably 0.0001 to 2.5 m², more preferably 0.0002 to 0.15 m², even more preferably 2.83 cm².

It will be apparent that step (α3) of the process according to the third aspect of the invention is conducted when the chamber K_{A} is at least partly laden with L₃ and K_{K} is at least partly laden with L₂, such that both L₃ and L₂ come into contact with the ASCs encompassed by the dividing wall W and especially also come into contact with the frame element R.

The fact that transfer of charge takes place between E_{A} and E_{K} in step (α3) implies that K_{K} and K_{A} are simultaneously laden with L₂ and L₃ respectively, such that they cover the electrodes E_{A} and E_{K} to such an extent that the circuit is complete.

This is the case especially when a liquid stream of L₃ is routed continuously through K_{A} and a liquid stream of L₂ through K_{K}, and the liquid stream of L₃ covers electrode E_{A} and the liquid stream of L₂ covers electrode E_{K} at least partly, preferably completely.

In a further preferred embodiment, the process according to the third aspect of the invention is performed continuously, i.e. step (α1) and step (α2) are performed continuously, while applying voltage as per step (α3).

After performance of step (α3), solution L₁ is obtained at the outlet A_{KK}, wherein the concentration of XOR in L₁ is higher than in L₂. If L₂ already comprised XOR, the concentration of XOR in L₁ is preferably 1.01 to 2.2 times, more preferably 1.04 to 1.8 times, even more preferably 1.077 to 1.4 times, even more preferably 1.077 to 1.08 times, higher than in L₂, most preferably 1.077 times higher than in L₂, where the proportion by mass of XOR in L₁ and in L₂ is more preferably in the range from 10% to 20% by weight, even more preferably 13% to 14% by weight.

An aqueous solution L₄ of S is obtained at the outlet A_{KA}, with a lower concentration of S in L₄ than in L₃.

The concentration of the cation X in the aqueous solution L₃ is preferably in the range of 3.5 to 5 mol/l, more preferably 4 mol/l. The concentration of the cation X in the aqueous solution L₄ is more preferably 0.5 mol/l lower than that of the aqueous solution L₃ used in each case.

More particularly, steps (α1) to (α3) of the process according to the third aspect of the invention are conducted at a temperature of 20° C. to 70° C., preferably 35° C. to 65° C., more preferably 35° C. to 60° C., even more preferably 35° C. to 50° C., and that a pressure of 0.5 bar to 1.5 bar, preferably 0.9 bar to 1.1 bar, more preferably 1.0 bar.

In the course of performance of steps (α1) to (α3) according to the third aspect of the process according to the invention, hydrogen is typically formed in the cathode chamber K_{K}, which can be removed from the cell together with solution L₁ via outlet A_{KK}. The mixture of hydrogen and solution L₁ can then, in a particular embodiment of the present invention, be separated by methods known to the person skilled in the art. When the alkali metal compound used is a halide, especially chloride, it is possible for chlorine or another halogen gas to form in the anode chamber K_{A}, and this can be removed from the cell together with solution L₄ via outlet A_{KK}. In addition, it is also possible for oxygen or/and carbon dioxide to form, which can likewise be removed. The mixture of chlorine, oxygen and/or CO₂ and solution L₄ can then, in a particular embodiment of the present invention, be separated by methods known to the person skilled in the art. It is then likewise possible, after the chlorine, oxygen and/or CO₂ gases have been separated from solution L₄, to separate these by methods known to the person skilled in the art.

4.3.2 Process According to the Invention in an Electrolysis Cell E with a Middle Chamber K_{M}

In the cases in which the electrolysis cell E comprises at least one middle chamber K_{M}, the steps (β1), (β2), (β3) that proceed simultaneously are conducted.

It is preferable that the electrolysis cell E comprises at least one middle chamber K_{M}, and then the steps (β1), (β2), (β3) that proceed simultaneously are conducted.

### 4.3.2.1 Step (β1)

In step (β1), a solution L₂ comprising the alcohol ROH, preferably comprising an alkali metal alkoxide XOR and alcohol ROH, is routed through K_{K}.

Solution L₂ is preferably free of water. What is meant in accordance with the invention by “free of water” is that the weight of water in solution L₂ based on the weight of the alcohol ROH in solution L₂ (mass ratio) is ≤1:10, more preferably ≤1:20, even more preferably ≤1:100, even more preferably ≤0.5:100.

If solution L₂ comprises XOR, the proportion by mass of XOR in solution L₂, based on the overall solution L₂, is especially >0% to 30% by weight, preferably 5% to 20% by weight, more preferably 10% to 20% by weight, more preferably 10% to 15% by weight, most preferably 13% to 14% by weight, at the very most preferably 13% by weight.

If solution L₂ comprises XOR, the mass ratio of XOR to alcohol ROH in solution L₂ is especially in the range of 1:100 to 1:5, more preferably in the range of 1:25 to 3:20, even more preferably in the range of 1:12 to 1:8, even more preferably 1:10.

### 4.3.2.2 Step (β2)

In step (β2), a neutral or alkaline aqueous solution L₃ of a salt S comprising X as cation is routed through K_{M}, then via V_{AM}, then through K_{A}.

The salt S is preferably a halide, sulfate, sulfite, nitrate, hydrogencarbonate or carbonate of X, even more preferably a halide.

Halides are fluorides, chlorides, bromides, iodides. The most preferred halide is chloride.

The pH of the aqueous solution L₃ is >7.0, preferably in the range of 7 to 12, more preferably in the range of 8 to 11, even more preferably 10 to 11, most preferably 10.5.

The proportion by mass of salt S in solution L₃ is preferably in the range of >0% to 20% by weight, preferably 1% to 20% by weight, more preferably 5% to 20% by weight, even more preferably 10% to 20% by weight, most preferably 20% by weight, based on the overall solution L₃.

### 4.3.2.3 Step (β3)

In step (β3), a voltage is then applied between E_{A} and E_{K}.

This results in transfer of current from the charge source to the anode, transfer of charge via ions to the cathode and ultimately transfer of current back to the charge source. The charge source is known to the person skilled in the art and is typically a rectifier that converts alternating current to direct current and can generate particular voltages via voltage transformers.

This in turn has the following consequences:
the solution L₁ is obtained at the outlet A_{KK} with a higher concentration of XOR in L₁ than in L₂,
an aqueous solution L₄ of S is obtained at the outlet A_{KA}, with a lower concentration of S in L₄ than in L₃.

In step (β3) of the process according to the third aspect the invention, in particular, such a voltage is applied that such a current flows such that the current density (=ratio of the current supplied to the electrolysis cell to the area of the solid-state electrolyte in contact with the anolyte present in the middle chamber K_{M}) is in the range from 10 to 8000 Nm², more preferably in the range from 100 to 2000 Nm², even more preferably in the range from 300 to 800 Nm², and even more preferably is 494 Nm². This can be determined in a standard manner by the person skilled in the art. The area of the solid-state electrolyte in contact with the anolyte present in the middle chamber K_{M} is especially 0.00001 to 10 m², preferably 0.0001 to 2.5 m², more preferably 0.0002 to 0.15 m², even more preferably 2.83 cm².

It will be apparent that step (β3) of the process according to the third aspect of the invention is conducted when the two chambers K_{M} and K_{A} are at least partly laden with L₃, and K_{K} is at least partly laden with L₂, such that both L₃ and L₂ come into contact with the solid-state electrolytes encompassed by the dividing wall W and especially also come into contact with the frame element R.

The fact that transfer of charge takes place between E_{A} and E_{K} in step (β3) implies that K_{K}, K_{M} and K_{A} are simultaneously laden with L₂ and L₃ such that they cover the electrodes E_{A} and E_{K} to such an extent that the circuit is complete.

This is the case especially when a liquid stream of L₃ is routed continuously through K_{M}, V_{AM} and K_{A} and a liquid stream of L₂ through K_{K}, and the liquid stream of L₃ covers electrode E_{A} and the liquid stream of L₂ covers electrode E_{K} at least partly, preferably completely.

In a further preferred embodiment, the process according to the third aspect of the invention is performed continuously, i.e. step (β1) and step (β2) are performed continuously, while applying voltage as per step (β3).

After performance of step (β3), solution L₁ is obtained at the outlet A_{KK}, wherein the concentration of XOR in L₁ is higher than in L₂. If L₂ already comprised XOR, the concentration of XOR in L₁ is preferably 1.01 to 2.2 times, more preferably 1.04 to 1.8 times, even more preferably 1.077 to 1.4 times, even more preferably 1.077 to 1.08 times, higher than in L₂, most preferably 1.077 times higher than in L₂, where the proportion by mass of XOR in L₁ and in L₂ is more preferably in the range from 10% to 20% by weight, even more preferably 13% to 14% by weight.

An aqueous solution L₄ of S is obtained at the outlet A_{KA}, with a lower concentration of S in L₄ than in L₃.

The concentration of the cation X in the aqueous solution L₃ is preferably in the range of 3.5 to 5 mol/l, more preferably 4 mol/l. The concentration of the cation X in the aqueous solution L₄ is more preferably 0.5 mol/l lower than that of the aqueous solution L₃ used in each case.

More particularly, steps (β1) to (β3) of the process according to the third aspect of the invention are conducted at a temperature of 20° C. to 70° C., preferably 35° C. to 65° C., more preferably 35° C. to 60° C., even more preferably 35° C. to 50° C., and at a pressure of 0.5 bar to 1.5 bar, preferably 0.9 bar to 1.1 bar, more preferably 1.0 bar.

In the course of performance of steps (β1) to (β3) according to the third aspect of the process according to the invention, hydrogen is typically formed in the cathode chamber K_{K}, which can be removed from the cell together with solution L₁ via outlet A_{KK}. The mixture of hydrogen and solution L₁ can then, in a particular embodiment of the present invention, be separated by methods known to the person skilled in the art. When the alkali metal compound used is a halide, especially chloride, it is possible for chlorine or another halogen gas to form in the anode chamber K_{A}, and this can be removed from the cell together with solution L₄ via outlet A_{KK}. In addition, it is also possible for oxygen or/and carbon dioxide to form, which can likewise be removed. The mixture of chlorine, oxygen and/or CO₂ and solution L₄ can then, in a particular embodiment of the present invention, be separated by methods known to the person skilled in the art. It is then likewise possible, after the chlorine, oxygen and/or CO₂ gases have been separated from solution L₄, to separate these by methods known to the person skilled in the art.

### 4.3.2.4 Additional Advantages of Steps (β1) to (β3)

This performance of steps (β1) to (β3) brings further surprising advantages that were not to be expected in the light of the prior art. Steps (β1) to (β3) of the process according to the invention protect the acid-labile solid-state electrolyte from corrosion without, as in the prior art, having to sacrifice alkoxide solution from the cathode space as buffer solution. Thus, the process according to the invention is more efficient than the procedure described in WO 2008/076327 A1, in which the product solution is used for the middle chamber, which reduces the overall conversion.

### 5. EXAMPLES

### 5.1 Comparative Example 1

Sodium methoxide (SM) was produced via a cathodic process, with supply of 20% by weight NaCl solution (in water) in the anode chamber and of 10% by weight methanolic SM solution in the cathode chamber. The electrolysis cell consisted of three chambers that corresponded to those shown in FIG. 1 B. The connection between middle chamber and anode chamber was established by a hose mounted at the base of the electrolysis cell. The anode chamber and middle chamber were separated by a 2.83 cm² anion exchange membrane (Tokuyama AMX, ammonium groups on polymer). Cathode chamber and middle chamber were separated by a ceramic of the NaSICON type with an area of 2.83 cm². The ceramic had a chemical composition of the formula Na_{3.4}Zr_{2.0}Si_{2.4}P_{0.6}O₁₂.

The anolyte was transferred through the middle chamber into the anode chamber. The flow rate of the anolyte was 1 I/h, that of the catholyte was 90 ml/h, and a current of 0.14 A was applied. The temperature was 35° C. The electrolysis was conducted for 500 hours at a constant voltage of 5 V. It was observed that a pH gradient developed in the middle chamber over a prolonged period, which is attributable to the migration of the ions to the electrodes in the course of the electrolysis and the spread of the protons formed in further reactions at the anode. This local increase in pH is undesirable since it can attack the solid-state electrolyte and can lead to corrosion and fracture of the solid-state electrolyte specifically in the case of very long periods of operation.

In addition, there is expansion and shrinkage of the NaSICON ceramic on account of the heating and cooling effects when the electrolysis cell is repeatedly started up and shut down. In addition, the NaSICON membrane may be displaced within the cell. This is problematic since the tendency of the ceramic to fracture is enhanced and can lead to leakage of electrolyte from the middle chamber into the cathode chamber, which waters down the electrolysis product. In addition, this can lead to leaks in the outer wall of the cell, which leads to leakage of electrolyte to the outside.

### 5.2 Comparative Example 2

Comparative Example 1 was repeated with a two-chamber cell comprising just one anode chamber and one cathode chamber, with the anode chamber separated from the cathode chamber by the ceramic of the NaSICON type (FIG. 1 A). This electrolysis cell thus did not contain any middle chamber. This is reflected in even faster corrosion of the ceramic compared to the comparative example 1, which leads to a rapid rise in the voltage curve. With a starting voltage value of <5 V, this rises to >20 V within 100 hours.

### 5.3 Inventive Example 1

Comparative Example 1 is repeated using an electrolysis cell according to FIG. 5 A in which a dividing wall comprising two NaSICON ceramics in a frame is inserted and secured with screws.

This arrangement reduces the extent of the expansion and shrinkage processes, which contributes to the service life of the ceramic and results in a cleaner product solution since the leakage is prevented.

### 5.4 Comparative Example 3

Comparative Example 2 is repeated using an electrolysis cell according to FIG. 5 B in which a dividing wall comprising four NaSICON ceramics in a frame is inserted and secured with hooks as shown in FIG. 7 A. The difference is, however, that the securing element B_{T} <92> (in cross section <166> in FIG. 5 B) is omitted.

This arrangement reduces the extent of the expansion and shrinkage processes, which contributes to the service life of the ceramic and results in a cleaner product solution since the leakage is prevented. However, it is observed that the frame R is flexible in the region of the separating element R_{T}, and hence the stability of the dividing wall W in this region is low.

### 5.5 Inventive Example 2

Comparative Example 3 is repeated, with attachment of a securing element B_{T} <92> (mutually engaging hooks) in the region of the separating element R_{T}. This distributes compression forces over the entire surface of the respective side of the dividing wall, which increases the stability of the dividing wall.

### 5.6 Result

The alleviation of the tensions within the solid-state electrolyte ceramics in the expansion and shrinkage processes which result from the repeated electrolysis cycles leads to an extension of the lifetime of the electrolysis chamber. In the execution according to Inventive Examples 1 and 2, these effects are reduced, which increases the stability of the solid-state electrolyte.

In addition, by comparison with Comparative Example 3, the stability of the dividing wall W is increased by homogeneous distribution of the compression forces exerted by the frame element on the ceramics in the dividing wall, by providing a securing element B_{T} in the region of the separating element R_{T}.

The use of a three-chamber cell according to the invention in the process according to the invention also prevents the corrosion of the solid-state electrolyte, and at the same time there is no need to sacrifice alkali metal alkoxide product for the middle chamber and the voltage is kept constant. These advantages that are already apparent from the comparison of the two Comparative Examples 1 and 2 underline the surprising effect of an electrolysis cell according to the invention comprising at least one middle chamber and the process conducted therein.

6. Reference symbols in the figures

| | | |
|---|---|---|
| Electrolysis cell | E | <1> |
| Anode chamber | K_{A} | <11> |
| Inlet | Z_{KA} | <110> |
| Outlet | A_{KA} | <111> |
| Interior | I_{KA} | <112> |
| Anodic electrode | E_{A} | <113> |
| Cathode chamber | K_{K} | <12> |
| Inlet | Z_{KK} | <120> |
| Outlet | A_{KK} | <121> |
| Interior | I_{KK} | <122> |
| Cathodic electrode | E_{K} | <123> |
| Middle chamber | K_{M} | <13> |
| Inlet | Z_{KM} | <130> |
| Outlet | A_{KM} | <131> |
| Interior | I_{KM} | <132> |
| Diffusion barrier | | <14> |
| Connection | V_{AM} | <15> |
| Dividing wall | W | <16> |
| Side | S_{KK} | <161> |
| Side | S_{A/MK} | <162> |
| Surface | O_{KK} | <163> |
| Surface | O_{A/MK} | <164> |
| Cross section through edge element R_{R} | Q_{RR} | <165> |
| Cross section through separating | Q_{RT} | <166> |
| element R_{T} | | |
| Solid-state electrolyte ceramic | F_{A} | <18> |
| Solid-state electrolyte ceramic | F_{B} | <19> |
| Solid-state electrolyte ceramic | F_{C} | <28> |
| Solid-state electrolyte ceramic | F_{D} | <29> |
| Solid-state electrolyte ceramics | F_{E}, F_{F}, | <30>, <31>, <32>, |
| | F_{G}, F_{H}, | <33>, <34> |
| | F_{I} | |
| Frame element | R | <2> |
| Edge element | R_{R} | <20> |
| Separating element | R_{T} | <17> |
| Frame part | R₁ | <201> |
| Frame part | R₂ | <202> |
| Seal | Di | <40> |
| Hinge | | <50> |
| Bulge (“rabbit's ear”) | | <60> |
| Additional hole | | <61> |
| Outer wall | W_{A} | <80> |
| Securing element | B_{R} | <91> |
| Securing element | B_{T} | <92> |
| Hook | B_{H} | <93> |
| Alkali metal alkoxide XOR in the | L₁ | <21> |
| alcohol ROH | | |
| Solution comprising the alcohol ROH | L₂ | <22> |
| Neutral or alkaline, aqueous solution | L₃ | <23> |
| of a salt S comprising X as cation | | |
| Aqueous solution of S, where | L₄ | <24> |
| [S]_{L4} < [S]_{L3}. | | |

1. A dividing wall W <16> comprising one side S_{KK} <161> having the surface O_{KK} <163> and, opposite the side S_{KK} <161>, a side S_{A/MK} <162> having the surface O_{A/MK} <164>,
wherein the dividing wall W <16> encompasses a frame element R <2> composed of two opposite parts R₁ <201> and R₂ <202>, with at least two alkali metal cation-conducting solid-state electrolyte ceramics F_{A} <18> and F_{B} <19> disposed therebetween,
wherein R₁ <201> is directly contactable via the surface O_{KK} <163>,
wherein R₂ <202> is directly contactable via the surface O_{A/MK} <164>,
wherein the frame element R <2> forms an edge element R_{R} <20> and a separating element R_{T} <17>,
wherein the edge element R_{R} <20> at least partly bounds the surfaces O_{KK} <163> and O_{A/MK} <164>,
and wherein the separating element R_{T} <17> lies between alkali metal cation-conducting solid-state electrolyte ceramics encompassed by the dividing wall W <16> and separates these from one another,
such that the alkali metal cation-conducting solid-state electrolyte ceramics encompassed by the dividing wall W <16> are directly contactable both via the surface O_{KK} <163> and via the surface O_{A/MK} <164>,
wherein
R₁ <201> and R₂ <202> are secured to one another by at least one securing element B_{R} <91> at the edge element R_{R} <20>,
and R₁ <201> and R₂ <202> are secured to one another by at least one securing element B_{T} <92> at the separating element R_{T} <17>.

2. The dividing wall W <16> according to claim 1, wherein the at least one securing element B_{R} <91> and the at least one securing element B_{T} <92> are in one-piece form together with at least one of parts R₁ <201> and R₂ <202>.

3. The dividing wall W <16> according to claim 1, wherein the at least one securing element B_{R} <91> and the at least one securing element B_{T} <92> are each in the form of mutually engaging hooks B_{H} <93>.

4. The dividing wall W <16> according to claim 1, comprising at least four alkali metal cation-conducting solid-state electrolyte ceramics F_{A} <18>, F_{B} <19>, F_{C} <28> and F_{D} <29>.

5. Dividing wall W <16> according to claim 4, wherein the separating element R_{T} <17> takes the form of a cross or grid.

6. The dividing wall W <16> according to claim 1, wherein the frame element R <2> comprises a material selected from the group consisting of plastic, glass, wood.

7. The dividing wall W <16> according to claim 1, wherein the alkali metal cation-conducting solid-state electrolyte ceramics encompassed by the dividing wall W <16> independently have a structure of the formula
$${M}_{1 + 2 w + x - y + z}^{I} {M}_{w}^{II} {M}_{x}^{III} {Zr}_{2 - w - x - y}^{I V} {{M}_{y}^{V} ( {SiO}_{4} )}_{z} {( {PO}_{4} )}_{3 - z} ,$$
where M^{I} is selected from Na⁺ and Li⁺,
M^{II} is a divalent metal cation,
M^{III} is a trivalent metal cation,
M^{V} is a pentavalent metal cation,
the Roman indices I, II, III, IV, V indicate the oxidation numbers in which the respective metal cations exist,
and w, x, y, z are real numbers, where 0≤x<2, 0≤y<2, 0≤w<2, 0≤z<3,
and where w, x, y, z are chosen such that 1+2w+x−y+z≥0 and 2−w−x−y≥0.

8. An electrolysis cell E <1> comprising
at least one anode chamber K_{A} <11> having at least one inlet Z_{KA} <110>, at least one outlet A_{KA} <111>, and an interior I_{KA} <112> comprising an anodic electrode E_{A} <113>,
at least one cathode chamber K_{K} <12> having at least one inlet Z_{KK} <120>, at least one outlet A_{KK} <121>, and an interior I_{KK} <122> comprising a cathodic electrode E_{K} <123>,
and optionally at least one interposed middle chamber K_{M} <13> having at least one inlet Z_{KM} <130>, at least one outlet A_{KM} <131> and an interior I_{KM} <132>,
where I_{KA} <112> and I_{KM} <132> are then divided from one another by a diffusion barrier D <14>, and A_{KM} <131> is connected by a connection V_{AM} <15> to the inlet Z_{KA} <110>, such that liquid can be passed from I_{KM} <132> into I_{KA} <112> via the connection V_{AM} <15>,
where
in the cases in which the electrolysis cell E <1> does not comprise a middle chamber K_{M} <13>, I_{KA} <112> and I_{KK} <122> are divided from one another by a dividing wall W <16> according to claim 1,
in the cases in which the electrolysis cell E <1> comprises at least one middle chamber K_{M} <13>, I_{KK} <122> and I_{KM} <132> are divided from one another by a dividing wall W <16> according to claim 1,
wherein
the alkali metal cation-conducting solid-state ceramics encompassed by the dividing wall W <16> directly contact the interior I_{KK} <122> on the S_{KK} side <161> via the surface O_{KK} <163>,
and
in the cases in which the electrolysis cell E <1> does not comprise a middle chamber K_{M} <13>, the alkali metal cation-conducting solid-state electrolyte ceramics encompassed by the dividing wall W <16> directly contact the interior I_{KA} <112> on the S_{A/MK} <162> side via the surface O_{A/MK} <164>,
in the cases in which the electrolysis cell E <1> comprises at least one middle chamber K_{M} <13>, the alkali metal cation-conducting solid-state electrolyte ceramics encompassed by the dividing wall W <16> directly contact the interior I_{KM} <132> on the S_{A/MK} <162> side via the surface O_{A/MK} <164>.

9. The electrolysis cell E <1> according to claim 8 which does not comprise a middle chamber K_{M} <13>.

10. The electrolysis cell E <1> according to claim 8 which comprises at least one middle chamber K_{M} <13>.

11. The electrolysis cell E <1> according to claim 10, wherein the connection V_{AM} <15> is formed within the electrolysis cell E <1>.

12. A process for producing a solution L₁ <21> of an alkali metal alkoxide XOR in the alcohol ROH, where X is an alkali metal cation and R is an alkyl radical having 1 to 4 carbon atoms,
(α) wherein the following steps (α1), (α2), (α3) that proceed simultaneously are conducted in the electrolysis cell E <1> according to claim 9:
(α1) a solution L₂ <22> comprising the alcohol ROH is routed through K_{K} <12>,
(α2) a neutral or alkaline, aqueous solution L₃ <23> of a salt S comprising X as cation is routed through K_{A} <11>,
(α3) voltage is applied between E_{A} <113> and E_{K} <123>.

13. The process according to claim 12, wherein X is selected from the group consisting of Li⁺, Na⁺, K⁺.

14. The process to claim 12, wherein S is a halide, sulfate, sulfite, nitrate, hydrogencarbonate or carbonate of X.

15. The process according to claim 12, wherein R is selected from the group consisting of methyl and ethyl.

16. A process for producing a solution L₁ <21> of an alkali metal alkoxide XOR in the alcohol ROH, where X is an alkali metal cation and R is an alkyl radical having 1 to 4 carbon atoms,
(β) wherein the following steps (β1), (β2), (β3) that proceed simultaneously are conducted in the electrolysis cell E <1> according to claim 10:
(β1) a solution L₂ <22> comprising the alcohol ROH is routed through K_{K} <12>,
(β2) a neutral or alkaline, aqueous solution L₃ <23> of a salt S comprising X as cation is routed through K_{M} <13>, then through V_{AM} <15>, then through K_{A} <11>,
(β) voltage is applied between E_{A} <113> and E_{K} <123>,
which affords the solution L₁ <21> at the outlet A_{KK} <121>, with a higher concentration of XOR in L₁ <21> than in L₂ <22>,
and which affords an aqueous solution L₄ <24> of S at the outlet A_{KA} <111>, with a lower concentration of S in L₄ <24> than in L₃ <23>.

17. The process according to claim 16, wherein X is selected from the group consisting of Li⁺, Na⁺, K⁺.

18. The process according to claim 16, wherein S is a halide, sulfate, sulfite, nitrate, hydrogencarbonate or carbonate of X.

19. The process according to claim 16, wherein R is selected from the group consisting of methyl and ethyl.
